(19) United States
(12) Patent Application Publication
(10) Pub. No.: US 2023/0058280 A1
(43) Pub. Date: Feb. 23, 2023

(54) METHOD AND DEVICE IN A NODE USED FOR WIRELESS COMMUNICATION

(71) Applicants: Qi JIANG, SHANGHAI (CN); Xiaobo ZHANG, SHANGHAI (CN)

(72) Inventors: Qi JIANG, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/975,629

(22) Filed: Oct. 28, 2022

Related U.S. Application Data
(63) Continuation of application No. PCT/CN2021/096665, filed on May 28, 2021.

(30) Foreign Application Priority Data
Jun. 2, 2020 (CN) 202010489719.1
Jun. 11, 2020 (CN) 202010527058.7

(51) Int. Cl. H04W 72/04

(52) U.S. Cl. CPC H04W 72/044

(57) ABSTRACT

Disclosure provides a method and device in a node for wireless communications. A node first receives first information, and then monitors a first-type signaling in a first time-frequency-resource pool; the first information is used to determine a first candidate parameter and a second candidate parameter; a target parameter is the first candidate parameter, or a target parameter is the second candidate parameter; the first time-frequency-resource pool comprises K1 Resource Element (RE) sets, the first-type signaling occupies one of the K1 RE sets; the target parameter is used for receiving the first-type signaling. The present disclosure associates spatial characteristics of the first time-frequency-resource pool with whether it is in the first time window or not, which ensures a more flexible spatial configuration of the control resource set, thus improving the overall performance.

### CROSS REFERENCE TO RELATED APPLICATIONS

This application is a continuation of International Application No.PCT/CN2021/096665, filed May 28, 2021, which claims the priority benefit of Chinese Patent Application No.202010489719.1, filed on Jun. 2, 2020, and claims the priority benefit of Chinese Patent Application No.202010527058.7, filed on Jun. 11, 2020 the full disclosure of which is incorporated herein by reference.

### BACKGROUND

### Technical Field

The present disclosure relates to transmission methods and devices in wireless communication systems, and in particular to a transmission scheme and device related to unlicensed spectrum in wireless communications.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary session decided to conduct the study of New Radio (NR), or what is called fifth Generation (5G). The work Item (WI) of NR was approved at the 3GPP RAN #75 plenary session to standardize the NR.

In the scenarios of massive antennas based on beam transmission combined with unlicensed spectrum, due to the increase of beams, the terminal needs to blindly detects a Physical Downlink Control Channel (PDCCH) in a search space set corresponding to multiple beams. In current NR, PDCCH candidates in the search space set are all semi-statically configured via a high-layer signaling. When a result of Listen-before talk (LBT) of a base station is uncertain, the actually-configured PDCCH candidates on the search space set do not need to be detected blindly, so that the reserved blind detection capability will be wasted.

One key technology of NR is to support beam-based signal transmissions, which is mainly applied to scenarios of enhancing coverage performance of NR devices working in millimeter wave frequency bands (e.g., frequency bands greater than 6 GHz). Besides, the beam-based transmission technology is also needed in low frequency bands (e.g., frequency bands less than 6 GHz) to support massive antennas. By weighting the antenna array, a radio frequency signal forms a strong beam in a specific spatial direction, while in other directions the signal is weak. At the same time, with the development of the terminal, when a terminal is equipped with multiple panels, the terminal can receive or transmit in multiple beam directions at the same time. At present, the terminal can be configured with up to 6 Control Resource Sets (CORESETs) and 10 Search Space Sets simultaneously in an activated Bandwidth Part (BWP) at a given time, and it also needs to reserve a monitoring for Common Search Space (CSS). When the terminal carries out wireless communications on unlicensed spectrum, whether the beam can be adopted by the base station and used for communications is subjected to whether channel sensing is passed, the above scenarios make the adoption of beams on CORESETs more flexible, which leads to the problem of insufficient number of CORESETs.

### SUMMARY

In the scenario of massive antennas based on beam transmission combined with unlicensed spectrum, due to the increase of beams and the uncertainty of the result of LBT, the number of conventional CORESETs cannot match beam scenarios with complicated changes. In view of the above application scenarios and requirements, the present disclosure discloses a solution, it should be noted that embodiments of the first node in the present disclosure and characteristics of the embodiments can be applied to the base station if no conflict is incurred, and the embodiments of the second node in the present disclosure and characteristics of the embodiments can be applied to the terminal. At the same time, the embodiments and the characteristics of the embodiments in the present disclosure may be mutually combined if no conflict is incurred.

Furthermore, though originally targeted at unlicensed spectrum scenarios, the present disclosure is also applicable to scenarios under licensed spectrum. Though originally targeted at multi-beam scenarios under massive antennas, the present disclosure is also applicable to scenarios of non-massive antennas, where similar technical effects can be achieved. Additionally, the adoption of a unified solution for various scenarios, including but not limited to communication scenarios between terminals and base stations, contributes to the reduction of hardware complexity and costs.

The present disclosure provides a method in a first node for wireless communications, comprising:
receiving first information; and
monitoring a first-type signaling in a first time-frequency-resource pool;
herein, the first information is used to determine a first candidate parameter and a second candidate parameter; a target parameter is the first candidate parameter, or a target parameter is the second candidate parameter; the first time-frequency-resource pool comprises K1 Resource Element (RE) sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

In one embodiment, one technical feature of the above method is in: configuring the first candidate parameter and the second candidate parameter for the first time-frequency-resource pool is equivalent to associating the first time-frequency-resource pool with two different beams, so as to increase beams needed to be monitored by the first node without extra time-frequency resources to adapt to multi-beam scenarios.

In one embodiment, another technical feature of the above method is in: by establishing an association between a beam used for monitoring the first time-frequency-resource pool and the first time window, different beams are used in a Channel Occupy Time (COT) and outside a COT respectively to perform a blind detection on a PDCCH in unlicensed spectrum scenarios, so as to configure an LBT-passed beam for the CORESET when the CORESET is in the COT to increase the possibility of scheduling, and configure different beams for the CORESETs when the CORESET is outside the COT to ensure the technical effects of coverage.

According to one aspect of the present disclosure, the first information comprises the first candidate parameter and the second candidate parameter, and the first information is used to indicate the first time-frequency-resource pool.

In one embodiment, one technical feature of the above method is in: the first candidate parameter and the second candidate parameter are directly indicated via first information to improve flexibility of configuration.

According to one aspect of the present disclosure, the first information only comprises one of the first candidate parameter or the second candidate parameter, one of the first candidate parameter or the second candidate parameter that is not comprised in the first information is configured via a higher-layer signaling, and the higher-layer signaling is used to indicate that the first candidate parameter is associated with the second candidate parameter.

In one embodiment, one technical feature of the above method is in: by indicating one of the first candidate parameter and the second candidate parameter, signaling overhead is saved and spectrum efficiency is increased.

According to one aspect of the present disclosure, comprising:
receiving a target signaling;
herein, the target signaling is used to determine the first time window.

In one embodiment, one technical feature of the above method is in: the target signaling is used to indicate a COT.

According to one aspect of the present disclosure, comprising:
receiving second information;
herein, the second information is used to indicate M1 candidate parameters, M1 being a positive integer greater than 1, and the first candidate parameter is one of the M1 candidate parameters.

According to one aspect of the present disclosure, comprising:
receiving a first signaling in a first RE set; and
receiving a target signal in a target time-frequency-resource block;
herein, the first RE set is one of the K1 RE sets, and the first signaling is the first-type signaling; the first signaling is used to indicate the target time-frequency-resource block.

According to one aspect of the present disclosure, comprising:
receiving a first signaling in a first RE set; and
transmitting a target signal in a target time-frequency-resource block;
herein, the first RE set is one of the K1 RE sets, and the first signaling is the first-type signaling; the first signaling is used to indicate the target time-frequency-resource block.

According to one aspect of the present disclosure, the first signaling is used to indicate a first parameter out of a first parameter set, and the first parameter is used for receiving the target signal; the first parameter set is one of a first-type parameter set or a second-type parameter set; whether the first time-frequency-resource pool belongs to the first time window in time domain is used to determine whether the first parameter set is the first-type parameter set or the second-type parameter set.

According to one aspect of the present disclosure, the first signaling is used to indicate a first parameter out of a first parameter set, and the first parameter is used for transmitting the target signal; the first parameter set is one of a first-type parameter set or a second-type parameter set; whether the first time-frequency-resource pool belongs to the first time window in time domain is used to determine whether the first parameter set is the first-type parameter set or the second-type parameter set.

In one embodiment, one technical feature of the above method is in: the first parameter set is related to both the first-type parameter set and the second-type parameter set, which further improves flexibility of beams adopted by the target signal, that is, flexibility of beams adopted by a data signal.

The present disclosure provides a method in a second node for wireless communications, comprising:
transmitting first information; and
transmitting a first-type signaling in a first time-frequency-resource pool;
herein, the first information is used to determine a first candidate parameter and a second candidate parameter; a target parameter is the first candidate parameter, or a target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

According to one aspect of the present disclosure, the first information comprises the first candidate parameter and the second candidate parameter, and the first information is used to indicate the first time-frequency-resource pool.

According to one aspect of the present disclosure, the first information only comprises one of the first candidate parameter or the second candidate parameter, one of the first candidate parameter or the second candidate parameter that is not comprised in the first information is configured via a higher-layer signaling, and the higher-layer signaling is used to indicate that the first candidate parameter is associated with the second candidate parameter.

According to one aspect of the present disclosure, comprising:
transmitting a target signaling;
herein, the target signaling is used to determine the first time window.

According to one aspect of the present disclosure, comprising:
transmitting second information;
herein, the second information is used to indicate M1 candidate parameters, M1 being a positive integer greater than 1, and the first candidate parameter is one of the M1 candidate parameters.

According to one aspect of the present disclosure, comprising:
transmitting a first signaling in a first RE set; and
transmitting a target signal in a target time-frequency-resource block;
herein, the first RE set is one of the K1 RE sets, and the first signaling is the first-type signaling; the first signaling is used to indicate the target time-frequency-resource block.

According to one aspect of the present disclosure, comprising:
transmitting a first signaling in a first RE set; and
receiving a target signal in a target time-frequency-resource block;
herein, the first RE set is one of the K1 RE sets, and the first signaling is the first-type signaling; the first signaling is used to indicate the target time-frequency-resource block.

According to one aspect of the present disclosure, the first signaling is used to indicate a first parameter out of a first parameter set, and the first parameter is used for transmitting the target signal; the first parameter set is one of a first-type parameter set or a second-type parameter set; whether the first time-frequency-resource pool belongs to the first time window in time domain is used to determine whether the first parameter set is the first-type parameter set or the second-type parameter set.

According to one aspect of the present disclosure, the first signaling is used to indicate a first parameter out of a first parameter set, and the first parameter is used for receiving the target signal; the first parameter set is one of a first-type parameter set or a second-type parameter set; whether the first time-frequency-resource pool belongs to the first time window in time domain is used to determine whether the first parameter set is the first-type parameter set or the second-type parameter set.

The present disclosure provides a first node for wireless communications, comprising:
a first receiver, which receives first information; and
a first transceiver, which monitors a first-type signaling in a first time-frequency-resource pool;
herein, the first information is used to determine a first candidate parameter and a second candidate parameter; a target parameter is the first candidate parameter, or a target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

The present disclosure provides a second node for wireless communications, comprising:
a first transmitter, which transmits first information; and
a second transceiver, which transmits a first-type signaling in a first time-frequency-resource pool;
herein, the first information is used to determine a first candidate parameter and a second candidate parameter; a target parameter is the first candidate parameter, or a target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

In one embodiment, the present disclosure has the following advantages over conventional schemes:
configuring the first candidate parameter and the second candidate parameter for the first time-frequency-resource pool is equivalent to associating the first time-frequency-resource pool with two different beams, so as to increase beams needed to be monitored by the first node without extra time-frequency resources to adapt to multi-beam scenarios.
by establishing an association between beams used for monitoring the first time-frequency-resource pool and the first time window, different beams are used in a COT and outside a COT respectively to perform a blind detection on a PDCCH in the unlicensed spectrum scenarios, so as to configure an LBT-passed beam for the CORESET when the CORESET is in the COT to increase the possibility of scheduling, and configure different beams for the CORESET when the CORESET is outside the COT to ensure the technical effects of coverage;
the first parameter set is related to both the first-type parameter set and the second-type parameter set, which further improves flexibility of beams adopted by the target signal, that is, flexibility of beams adopted by a data signal.

The present disclosure provides a method in a first node for wireless communications, comprising:
receiving a first information block; and
monitoring X control channel candidates in a target time-frequency-resource pool, the X being a positive integer greater than 1;
herein, the first information block is used to indicate a first time-frequency-resource set and a second time-frequency-resource set; the target time-frequency-resource pool comprises time-frequency resources belonging to a first time window in time domain comprised in the first time-frequency-resource set, and the target time-frequency-resource pool comprises time-frequency resources belonging to a second time window in time domain comprised in the second time-frequency-resource set; the first time window is different from the second time window, and a relative position relation between the first time window and the second time window is used to determine time-frequency distribution of the X control channel candidates in the target time-frequency-resource pool.

In one embodiment, one technical feature of the above method is in: the first node dynamically adjust distribution of the X control channel candidates in the first time-frequency-resource set and a second time-frequency-resource set according to a relative position relation of the first time window and the second time window; when the first time-frequency-resource set and the second time-frequency-resource set respectively belong to two overlapped COTs, the first node blindly detects a PDCCH in both the first time-frequency-resource set and the second time-frequency-resource set, so as to improve the possibility of being scheduled; when only one of the first time-frequency-resource set and the second time-frequency-resource set belongs to a COT, the first node blindly detects a PDCCH only in a time-frequency-resource set belonging to a COT, thus reducing power consumption and the probability of error detection.

According to one aspect of the present disclosure, the first time-frequency-resource set and the second time-frequency-resource set are respectively associated with a first candidate parameter and a second candidate parameter; the first candidate parameter is used for receiving a signal in the first time-frequency-resource set, and the second candidate parameter is used for receiving a signal in the second time-frequency-resource set.

In one embodiment, one technical feature of the above method is in: the first time-frequency-resource set and the second time-frequency-resource set respectively correspond to two different beamforming vectors to adapt to multi-beam scenarios.

According to one aspect of the present disclosure, the first time window and the second time window are overlapped in time domain, there at least exists one of the X control channel candidates belonging to the first time-frequency-resource set, and there at least exists another one of the X control channel candidates belonging to the second time-frequency-resource set.

According to one aspect of the present disclosure, the first time window and the second time window are orthogonal in time domain; any of the X control channel candidates belongs to a first time-frequency resource subset, or any of the X control channel candidates belongs to a second time-frequency resource subset; the first time-frequency resource subset is time-frequency resources belonging to a first time window in time domain comprised in the first time-frequency-resource set, and the second time-frequency resource subset is time-frequency resources belonging to a second time window in time domain comprised in the second time-frequency-resource set.

According to one aspect of the present disclosure, the first time-frequency-resource set is configured with K1 control channel candidates, the second time-frequency-resource set is configured with K2 control channel candidates, a sum of the K1 and the K2 is greater than the X, and the K1 and the K2 are positive integers greater than 1; X1 control channel candidate(s) out of the K1 control channel candidates belongs(belong) to the X control channel candidates, and X2 control channel candidate(s) out of the K2 control channel candidates belongs(belong) to the X control channel candidates; a sum of the X1 and the X2 is equal to the X; a sum of the K1 and the K2 is equal to K, and the X1 is linearly related to a ratio of the K1 to the K, and the X2 is linearly related to a ratio of the K2 to the K.

In one embodiment, one technical feature of the above method is in: a maximum blind detection times configured in the first time-frequency-resource set and the second time-frequency-resource set exceed the actual capacity of the first node; when the first time-frequency-resource set and the second time-frequency-resource set both belong to a COT, the first node needs to perform scaling on blind detection times allocated to the first time-frequency-resource set and blind detection times allocated to the second time-frequency-resource set, so as to ensure that capacity of the first node is not exceeded.

According to one aspect of the present disclosure, comprising:
transmitting target information;
herein, the target information is used to indicate that the first node supports M1 control resource set pools, M1 being a positive integer greater than 1; the first time-frequency-resource set and the second time-frequency-resource set respectively belong to two different control resource set pools in the K1 control resource set pools.

In one embodiment, one technical feature of the above method is in: the first node informs the network that the first node supports simultaneous transmission of multiple panels by reporting its own capability.

According to one aspect of the present disclosure, comprising:
receiving a first signaling;
herein, the first signaling is used to determine the first time window.

According to one aspect of the present disclosure, comprising:
receiving a second signaling;
herein, the second signaling is used to determine the second time window.

According to one aspect of the present disclosure, comprising:
receiving a target signaling in a first control channel candidate; and
receiving a target signal in a target time-frequency-resource block;
herein, the first control channel candidate is one of the X control channel candidates; and the target signaling is used to indicate the target time-frequency-resource block.

According to one aspect of the present disclosure, comprising:
receiving a target signaling in a first control channel candidate; and
transmitting a target signal in a target time-frequency-resource block;
herein, the first control channel candidate is one of the X control channel candidates; and the target signaling is used to indicate the target time-frequency-resource block.

According to one aspect of the present disclosure, the target signaling is used to indicate a first parameter out of a first parameter set, and the first parameter is used for receiving the target signal, or the first parameter is used for transmitting the target signal; the first parameter set is one of a first-type parameter set or a second-type parameter set; the first-type parameter set and the second-type parameter set are respectively associated with the first time-frequency-resource set and the second time-frequency-resource set; the first control channel candidate belongs to the first time-frequency-resource set, and the first parameter set is the first-type parameter set; or, the first control channel candidate belongs to the second time-frequency-resource set, and the first parameter set is the second-type parameter set.

In one embodiment, one technical feature of the above method is in: the first parameter set is related to both the first-type parameter set and the second-type parameter set, which further improves flexibility of beams adopted by the target signal, that is, flexibility of beams adopted by a data signal.

The present disclosure provides a method in a second node for wireless communications, comprising:
transmitting a first information block; and
transmitting a target signaling in a target time-frequency-resource pool;
herein, the target time-frequency-resource pool comprises X control channel candidates, the X being a positive integer greater than 1; the target signaling occupies one of the X control channel candidates; the first information block is used to indicate a first time-frequency-resource set and a second time-frequency-resource set; the target time-frequency-resource pool comprises time-frequency resources belonging to a first time window in time domain comprised in the first time-frequency-resource set, and the target time-frequency-resource pool comprises time-frequency resources belonging to a second time window in time domain comprised in the second time-frequency-resource set; the first time window is different from the second time window, and a relative position relation between the first time window and the second time window is used to determine time-frequency distribution of the X control channel candidates in the target time-frequency-resource pool.

According to one aspect of the present disclosure, the first time-frequency-resource set and the second time-frequency-resource set are respectively associated with a first candidate parameter and a second candidate parameter; the first candidate parameter is used for receiving a signal in the first time-frequency-resource set, and the second candidate parameter is used for receiving a signal in the second time-frequency-resource set.

According to one aspect of the present disclosure, the first time window and the second time window are overlapped in time domain, there at least exists one of the X control channel candidates belonging to the first time-frequency-resource set, and there at least exists another one of the X control channel candidates belonging to the second time-frequency-resource set.

According to one aspect of the present disclosure, the first time window and the second time window are orthogonal in time domain; any of the X control channel candidates belongs to a first time-frequency resource subset, or any of the X control channel candidates belongs to a second time-frequency resource subset; the first time-frequency resource subset is time-frequency resources belonging to a first time window in time domain comprised in the first time-frequency-resource set, and the second time-frequency resource subset is time-frequency resources belonging to a second time window in time domain comprised in the second time-frequency-resource set.

According to one aspect of the present disclosure, the first time-frequency-resource set is configured with K1 control channel candidates, the second time-frequency-resource set is configured with K2 control channel candidates, a sum of the K1 and the K2 is greater than the X, and the K1 and the K2 are positive integers greater than 1; X1 control channel candidate(s) out of the K1 control channel candidates belongs(belong) to the X control channel candidates, and X2 control channel candidate(s) out of the K2 control channel candidates belongs(belong) to the X control channel candidates; a sum of the X1 and the X2 is equal to the X; a sum of the K1 and the K2 is equal to K, and the X1 is linearly related to a ratio of the K1 to the K, and the X2 is linearly related to a ratio of the K2 to the K.

According to one aspect of the present disclosure, comprising:
receiving target information;
herein, the target information is used to indicate that a transmitter of the target information supports M1 control resource set pools, M1 being a positive integer greater than 1; the first time-frequency-resource set and the second time-frequency-resource set respectively belong to two different control resource set pools in the K1 control resource set pools.

According to one aspect of the present disclosure, comprising:
transmitting a first signaling;
herein, the first signaling is used to determine the first time window.

According to one aspect of the present disclosure, comprising:
transmitting a second signaling;
herein, the second signaling is used to determine the second time window.

According to one aspect of the present disclosure, comprising:
determining a first control channel candidate; and
transmitting a target signal;
herein, the first control channel candidate is one of the X control channel candidates; the target signaling occupies the first control channel candidate; and the target signaling is used to indicate the target time-frequency-resource block.

According to one aspect of the present disclosure, comprising:
determining a first control channel candidate; and
receiving a target signal;
herein, the first control channel candidate is one of the X control channel candidates; the target signaling occupies the first control channel candidate; and the target signaling is used to indicate the target time-frequency-resource block.

According to one aspect of the present disclosure, the target signaling is used to indicate a first parameter out of a first parameter set, and the first parameter is used for receiving the target signal, or the first parameter is used for transmitting the target signal; the first parameter set is one of a first-type parameter set or a second-type parameter set; the first-type parameter set and the second-type parameter set are respectively associated with the first time-frequency-resource set and the second time-frequency-resource set; the first control channel candidate belongs to the first time-frequency-resource set, and the first parameter set is the first-type parameter set; or, the first control channel candidate belongs to the second time-frequency-resource set, and the first parameter set is the second-type parameter set.

The present disclosure provides a first node for wireless communications, comprising:
a first transceiver, which receives a first information block; and
a second transceiver, which monitors X control channel candidates in a target time-frequency-resource pool, the X being a positive integer greater than 1;
herein, the first information block is used to indicate a first time-frequency-resource set and a second time-frequency-resource set; the target time-frequency-resource pool comprises time-frequency resources belonging to a first time window in time domain comprised in the first time-frequency-resource set, and the target time-frequency-resource pool comprises time-frequency resources belonging to a second time window in time domain comprised in the second time-frequency-resource set; the first time window is different from the second time window, and a relative position relation between the first time window and the second time window is used to determine time-frequency distribution of the X control channel candidates in the target time-frequency-resource pool.

The present disclosure provides a second node for wireless communications, comprising:
a third transceiver, which transmits a first information block; and
a fourth transceiver, which transmits a target signaling in a target time-frequency-resource pool;
herein, the target time-frequency-resource pool comprises X control channel candidates, the X being a positive integer greater than 1; the target signaling occupies one of the X control channel candidates; the first information block is used to indicate a first time-frequency-resource set and a second time-frequency-resource set; the target time-frequency-resource pool comprises time-frequency resources belonging to a first time window in time domain comprised in the first time-frequency-resource set, and the target time-frequency-resource pool comprises time-frequency resources belonging to a second time window in time domain comprised in the second time-frequency-resource set; the first time window is different from the second time window, and a relative position relation between the first time window and the second time window is used to determine time-frequency distribution of the X control channel candidates in the target time-frequency-resource pool.

In one embodiment, the present disclosure has the following advantages over conventional schemes:
the first node dynamically adjust distribution of the X control channel candidates in the first time-frequency-resource set and a second time-frequency-resource set according to a relative position relation of the first time window and the second time window; when the first time-frequency-resource set and the second time-frequency-resource set respectively belong to two overlapped COTs, the first node blindly detects a PDCCH in both the first time-frequency-resource set and the second time-frequency-resource set, so as to improve the possibility of being scheduled; when only one of the first time-frequency-resource set and the second time-frequency-resource set belongs to a COT, the first node blindly detects a PDCCH only in a time-frequency-resource set belonging to a COT, thus reducing power consumption and the probability of error detection;
the first time-frequency-resource set and the second time-frequency-resource set respectively correspond to two different beamforming vectors to adapt to multi-beam scenarios.
a maximum blind detection times configured in the first time-frequency-resource set and the second time-frequency-resource set exceed the actual capacity of the first node; when the first time-frequency-resource set and the second time-frequency-resource set both belong to a COT, the first node needs to perform scaling on blind detection times allocated to the first time-frequency-resource set and blind detection times allocated to the second time-frequency-resource set, so as to ensure that capacity of the first node is not exceeded.

### BRIEF DESCRIPTION OF THE DRAWINGS

Other features, objects and advantages of the present disclosure will become more apparent from the detailed description of non-restrictive embodiments taken in conjunction with the following drawings:

FIG. 1A illustrates a flowchart of the processing of a first node according to one embodiment of the present disclosure.

FIG. 1B illustrates a flowchart of the processing of a first node according to one embodiment of the present disclosure.

FIG. 2 illustrates a schematic diagram of a network architecture according to one embodiment of the present disclosure.

FIG. 3 illustrates a schematic diagram of a radio protocol architecture of a user plane and a control plane according to one embodiment of the present disclosure.

FIG. 4 illustrates a schematic diagram of a first communication device and a second communication device according to one embodiment of the present disclosure.

FIG. 5A illustrates a flowchart of first information according to one embodiment of the present disclosure.

FIG. 5B illustrates a flowchart of a first information block according to one embodiment of the present disclosure.

FIG. 6A illustrates a flowchart of a target signal according to one embodiment of the present disclosure.

FIG. 6B illustrates a flowchart of a target signal according to one embodiment of the present disclosure.

FIG. 7A illustrates a flowchart of a second signal according to another embodiment of the present disclosure.

FIG. 7B illustrates a flowchart of a target signal according to another embodiment of the present disclosure.

FIG. 8A illustrates a schematic diagram of a first time-frequency-resource pool according to one embodiment of the present disclosure.

FIG. 8B illustrates a flowchart of a first signaling and a second signaling according to one embodiment of the present disclosure.

FIG. 9A illustrates a schematic diagram of first information according to one embodiment of the present disclosure.

FIG. 9B illustrates a schematic diagram of a first time-frequency-resource pool and a second time-frequency-resource pool according to one embodiment of the present disclosure.

FIG. 10A illustrates a schematic diagram of first information according to another embodiment of the present disclosure.

FIG. 10B illustrates a schematic diagram of a first time window and a second time window according to one embodiment of the present disclosure.

FIG. 11A illustrates a schematic diagram of a first signaling and a target signaling according to one embodiment of the present disclosure.

FIG. 11B illustrates a schematic diagram of a first time window and a second time window according to another embodiment of the present disclosure.

FIG. 12A illustrates a schematic diagram of a first-type parameter set and a second-type parameter set according to one embodiment of the present disclosure.

FIG. 12B illustrates a schematic diagram of a first time window and a second time window according to another embodiment of the present disclosure.

FIG. 13A illustrates a structure block diagram of a processing device in a first node according to one embodiment of the present disclosure.

FIG. 13B illustrates a schematic diagram of a first-type parameter set and a second-type parameter set according to one embodiment of the present disclosure.

FIG. 14A illustrates a structure block diagram of a processing device in second node according to one embodiment of the present disclosure.

FIG. 14B illustrates a schematic diagram of a target signaling and a target signal according to one embodiment of the present disclosure.

FIG. 15 illustrates a structure block diagram of a processing device in a first node according to one embodiment of the present disclosure.

FIG. 16 illustrates a structure block diagram of a processing device in second node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1A

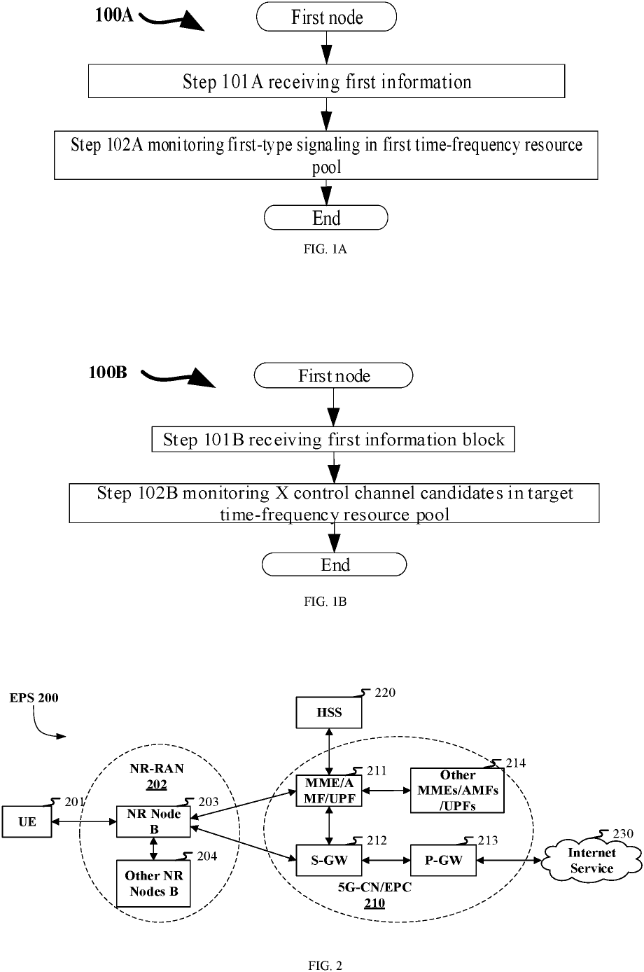

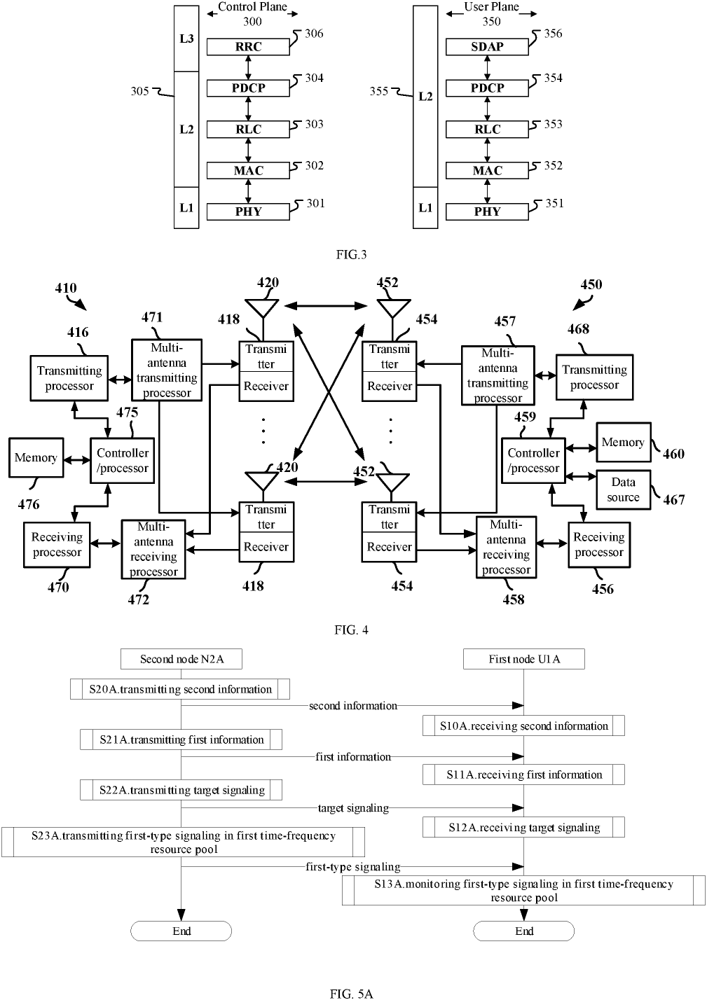

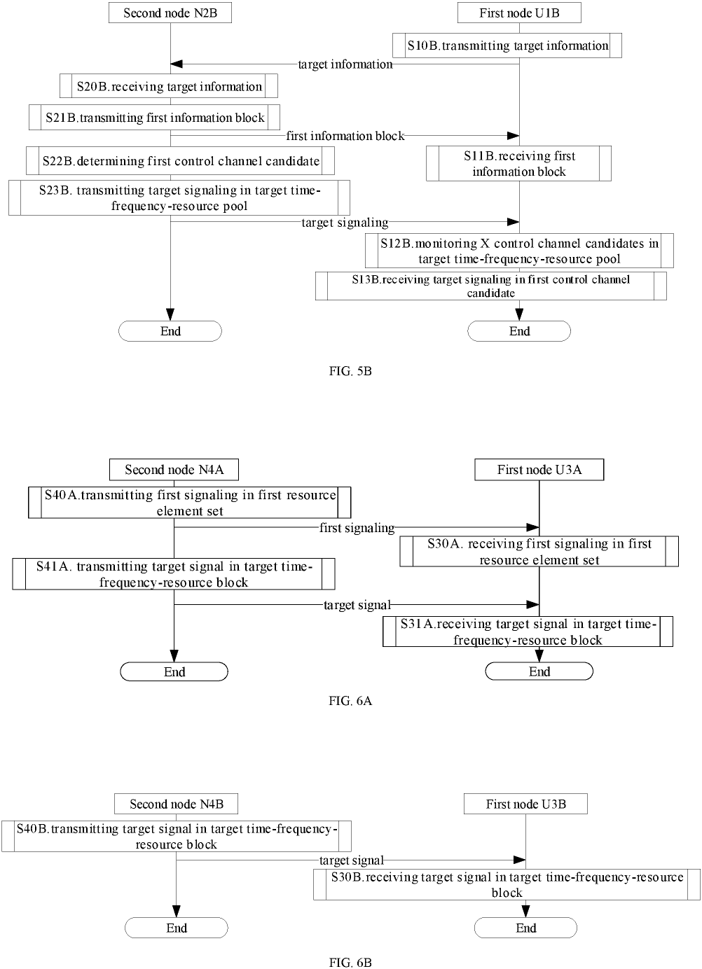

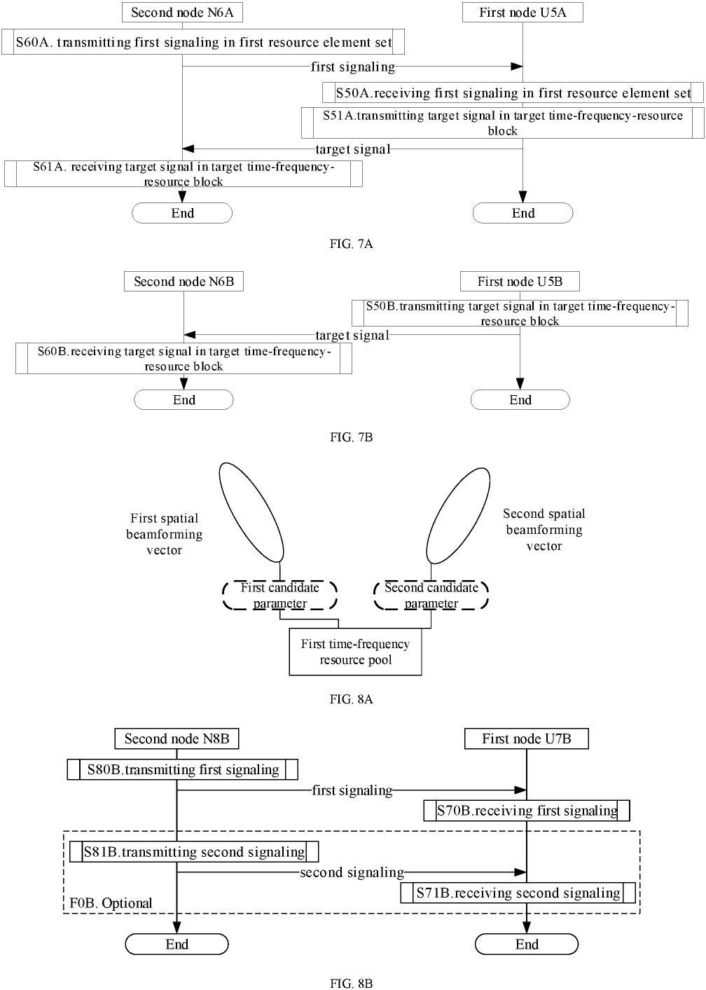

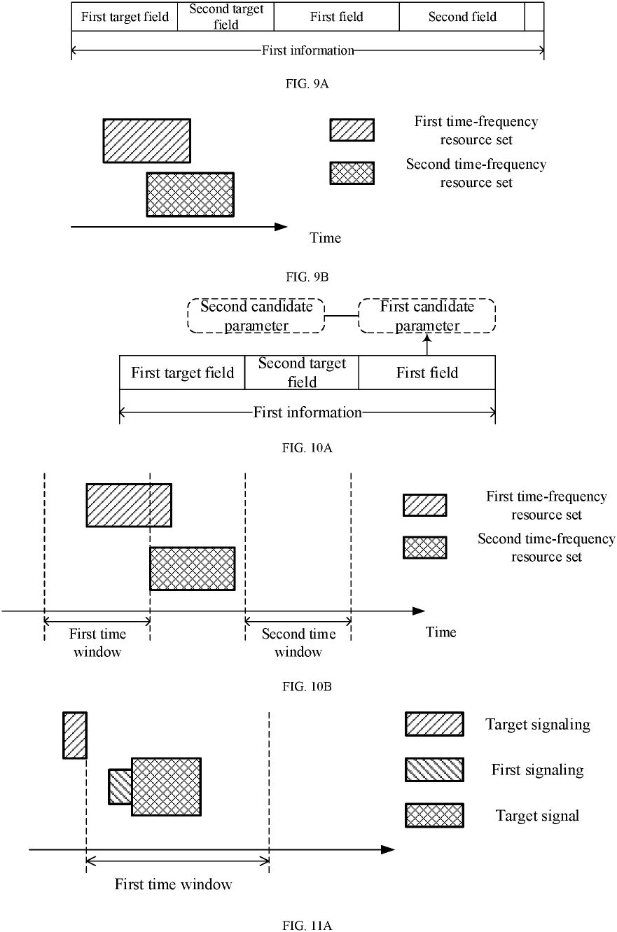

Embodiment 1A illustrates a processing flowchart of a first node, as shown in FIG. 1A. In step 100A illustrated by FIG. 1A, each box represents a step. In Embodiment 1A, a first node in the present disclosure first receives first information in step 101A, and monitors a first-type signaling in a first time-frequency-resource pool in step 102A.

In embodiment 1A, the first information is used to determine a first candidate parameter and a second candidate parameter; a target parameter is the first candidate parameter, or a target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

In one embodiment, the first information is carried by a Medium Access Control (MAC) Control Element (CE).

In one embodiment, the first information is transmitted on a Physical Downlink Shared Channel (PDSCH).

In one embodiment, the first information is carried via Downlink Control Information (DCI).

In one embodiment, the first information is transmitted on a PDCCH.

In one embodiment, the first information is UE-specific.

In one embodiment, the first time-frequency-resource pool occupies at least one RE.

In one embodiment, the first time-frequency-resource pool is a CORESET.

In one embodiment, the first time-frequency-resource pool corresponds to a CORESET identity (ID).

In one embodiment, the first time-frequency-resource pool is a Search Space Set.

In one embodiment, the first time-frequency-resource pool corresponds to a Search Space ID.

In one embodiment, the first time-frequency-resource pool belongs to two different CORESET Pools.

In one embodiment, the first time-frequency-resource pool belongs to two different Search Space Set Groups.

In one embodiment, the first information is used to explicitly indicate the first candidate parameter and the second candidate parameter.

In one embodiment, the first information is used to implicitly indicate the first candidate parameter and the second candidate parameter.

In one embodiment, the first information is used to explicitly indicate the first candidate parameter, and the first candidate parameter is associated with the second candidate parameter.

In one embodiment, the first information is used to explicitly indicates the second candidate parameter, and the second candidate parameter is associated with the first candidate parameter.

In one embodiment, the first candidate parameter is a Transmission Configuration Indication-State (TCI-State).

In one embodiment, the first candidate parameter corresponds to a TCI-StateID.

In one embodiment, the first candidate parameter corresponds to a first candidate signal.

In one subembodiment of the above embodiment, the first candidate signal comprises Channel-State Information Reference Signals (CSI-RS).

In one subembodiment of the above embodiment, the first candidate signal comprises an SS/PBCH Block (SSB).

In one subembodiment of the above embodiment, the first candidate signal is transmitted on a CSI-RS resource.

In one subembodiment of the above embodiment, the first candidate signal is transmitted on an SSB resource.

In one embodiment, the second candidate parameter is a TCI-State.

In one embodiment, the second candidate parameter corresponds to a TCI-StateID.

In one embodiment, the second candidate parameter corresponds to a second candidate signal.

In one subembodiment of the above embodiment, the second candidate signal comprises a CSI-RS.

In one subembodiment of the above embodiment, the second candidate signal comprises an SSB.

In one subembodiment of the above embodiment, the second candidate signal is transmitted on a CSI-RS resource.

In one subembodiment of the above embodiment, the second candidate signal is transmitted on an SSB resource.

In one embodiment, any of the K1 RE set is a PDCCH Candidate.

In one embodiment, any of the K1 RE set occupies at least one RE.

In one embodiment, any of the K1 RE set comprises at least one Control Channel Element (CCE).

In one embodiment, there at least exist two of the K1 RE sets occupying different numbers of REs.

In one embodiment, there at least exist two of the K1 RE sets occupying different numbers of CCEs.

In one embodiment, there at least exist two of the K1 RE sets adopting different ALs.

In one embodiment, the first-type signaling is a physical-layer signaling.

In one embodiment, the first-type signaling is DCI.

In one embodiment, the first-type signaling is a PDCCH.

In one embodiment, the first node blindly detects the first-type signaling in the first time-frequency-resource pool.

In one embodiment, the phrase that the target parameter is used for receiving the first-type signaling includes: the target parameter is used to determine a Spatial Rx Parameter of the first-type signaling.

In one embodiment, the phrase that the target parameter is used for receiving the first-type signaling includes: the target parameter is used to indicate a target reference signal, and a Spatial Rx Parameter of the target reference signal is used to determine a Spatial Rx Parameter of the first-type signaling.

In one embodiment, the phrase that the target parameter is used for receiving the first-type signaling includes: the target parameter is used to indicate a target reference signal, and the target reference signal is Quasi Co-located (QCL) with the first-type signaling.

In one subembodiment of the above two embodiments, the target reference signal comprises a CSI-RS.

In one subembodiment of the above two embodiments, the target reference signal comprises an SSB.

In one subembodiment of the above two embodiments, the target reference signal is transmitted on a CSI-RS resource.

In one subembodiment of the above two embodiments, the target reference signal is transmitted on an SSB resource.

In one embodiment, the target parameter is used for performing a blind detection on the first-type signaling on any of the K1 RE sets.

In one subembodiment of the above embodiment, the phrase that the target parameter is used for performing a blind detection on the first-type signaling on any of the K1 RE sets includes: the target parameter is used to indicate a target reference signal, and a Spatial Rx Parameter of the target reference signal is used to determine a Spatial Rx Parameter of a radio signal received on any of the K1 RE sets.

In one embodiment, the phrase that the target parameter is used for receiving the first-type signaling includes: the target parameter is used to indicate a target reference signal, and the first node assumes that the target reference signal is QCL with a radio signal received on any of the K1 RE sets when performing a blind detection on the first-type signaling.

In one embodiment, the first time-frequency pool belongs to the first time window in time domain, and the target parameter is the first candidate parameter.

In one embodiment, the first time-frequency pool does not belong to the first time window in time domain, and the target parameter is the second candidate parameter.

In one embodiment, the first time window comprises at least one consecutive slot.

In one embodiment, the first time-frequency-resource pool is associated with a first CORESET, and the first candidate parameter and the second candidate parameter both correspond to the first CORESET.

In one embodiment, the first information is used to indicate that both the first candidate parameter and the second candidate parameter correspond to the first CORESET.

In one embodiment, a start time of the first time window in time domain is indicated via a physical-layer dynamic signaling transmitted by a transmitter of the first information.

In one embodiment, a duration of the first time window in time domain is fixed.

In one embodiment, a duration of the first time window in time domain is configured via a higher-layer signaling.

In one embodiment, the monitoring a first-type signaling includes that the first node blindly detects the first-type signaling.

In one embodiment, the monitoring a first-type signaling includes that the first node receive the first-type signaling.

In one embodiment, the monitoring a first-type signaling includes that the first node decodes the first-type signaling through coherent detection.

In one embodiment, the monitoring a first-type signaling includes that the first node decodes the first-type signaling through energy detection.

In one embodiment, frequency-domain resources occupied by the first-type signaling are between 450 MHz to 6 GHz.

In one embodiment, frequency-domain resources occupied by the first-type signaling are between 24.25 GHz to 52.6 GHz.

In one embodiment, the first node detects the first-type signaling in one of the K1 RE sets.

In one embodiment, the first node detects multiple the first-type signalings in multiple of the K1 RE sets.

In one embodiment, a Cyclic Redundancy Check (CRC) comprised in the first-type signaling is scrambled through a Cell Radio Network Temporary Identifier (C-RNTI) allocated to the first node.

In one embodiment, a given RE set is any of the K1 RE sets, for the RE set, the first node adopts a C-RNTI allocated to the first node to descramble a CRC demodulated by the given RE set to judge whether the given RE set carries the first-type signaling.

### Embodiment 1B

Embodiment 1B illustrates a flowchart of processing of a first node, as shown in FIG. 1B. In step 100B illustrated by FIG. 1B, each box represents a step. In embodiment 1B, a first node in the present disclosure first receives a first information block in step 101B, then monitors X control channel candidates in a target time-frequency-resource pool in step 102B, where the X being a positive integer greater than 1.

In embodiment 1B, the first information block is used to indicate a first time-frequency-resource set and a second time-frequency-resource set; the target time-frequency-resource pool comprises time-frequency resources belonging to a first time window in time domain comprised in the first time-frequency-resource set, and the target time-frequency-resource pool comprises time-frequency resources belonging to a second time window in time domain comprised in the second time-frequency-resource set; the first time window is different from the second time window, and a relative position relation between the first time window and the second time window is used to determine time-frequency distribution of the X control channel candidates in the target time-frequency-resource pool.

In one embodiment, the first information block is used to indicate time-domain resources occupied by the first time-frequency-resource set.

In one embodiment, the first information block is used to indicate frequency-domain resources occupied by the first time-frequency-resource set.

In one embodiment, the first information block is used to indicate time-domain resources occupied by the second time-frequency-resource set.

In one embodiment, the first information block is used to indicate frequency-domain resources occupied by the second time-frequency-resource set.

In one embodiment, the first information block is carried by a Radio Resource Control (RRC) signaling.

In one embodiment, the first information block is carried by a MAC CE.

In one embodiment, the first information block comprises one or more fields in a ControlResourceSet in TS 38.331.

In one embodiment, the first information block comprises one or more fields in a SearchSpace in TS 38.331.

In one embodiment, the first information block comprises one or more fields in a PDCCH-Config in TS 38.331.

In one embodiment, a name of the first information block includes Panel.

In one embodiment, a name of the first information block includes CORESET.

In one embodiment, a name of the first information block includes SearchSpace.

In one embodiment, a name of the first information block includes PDCCH.

In one embodiment, the first time-frequency-resource set is a CORESET.

In one embodiment, the first time-frequency-resource set corresponds to a CORESET ID.

In one embodiment, the first time-frequency-resource set belongs to a CORESET Pool.

In one embodiment, the first time-frequency-resource set is a search space set.

In one embodiment, the first time-frequency-resource set corresponds to a Search Space ID.

In one embodiment, the first time-frequency-resource set belongs to a search space set group.

In one embodiment, the second time-frequency-resource set is a CORESET.

In one embodiment, the second time-frequency-resource set corresponds to a CORESET ID.

In one embodiment, the second time-frequency-resource set belongs to a CORESET Pool.

In one embodiment, the second time-frequency-resource set is a search space set.

In one embodiment, the second time-frequency-resource set corresponds to a Search Space ID.

In one embodiment, the second time-frequency-resource set belongs to a search space set group.

In one embodiment, time-domain resources occupied by the first time-frequency-resource set and time-domain resources occupied by the second time-frequency set are overlapped.

In one embodiment, there at least exist one Orthogonal Frequency Division Multiplexing (OFDM) symbol being occupied by the first time-frequency-resource set and the second time-frequency-resource set.

In one embodiment, frequency-domain resources occupied by the first time-frequency-resource set and frequency-domain resources occupied by the second time-frequency set are orthogonal.

In one embodiment, the first time-frequency-resource set occupies at least one RE.

In one embodiment, the second time-frequency-resource set occupies at least one RE.

In one embodiment, the X control channel candidates are X PDCCH candidates respectively.

In one embodiment, the X control channel candidates are X Physical Sidelink Control Channel (PSCCH) candidates respectively.

In one embodiment, the first time window is a COT.

In one embodiment, the first time window is a slot in a COT.

In one embodiment, the first time window is a mini-slot in a COT.

In one embodiment, the first time window is a sub-slot in a COT.

In one embodiment, the first time window comprises more than one consecutive slots.

In one embodiment, the second time window is a COT.

In one embodiment, the second time window is a slot in a COT.

In one embodiment, the second time window is a mini-slot in a COT.

In one embodiment, the second time window is a sub-slot in a COT.

In one embodiment, the second time window comprises more than one consecutive slots.

In one embodiment, the phrase that the target time-frequency-resource pool comprises time-frequency resources belonging to a first time window in time domain comprised in the first time-frequency-resource set includes: the target time-frequency-resource pool comprises a first time-frequency resource subset, the first time-frequency resource subset and the first time-frequency-resource set occupy same frequency-domain resources, a part of time-domain resources occupied by the first time-frequency-resource set belong to the first time window, and time-domain resources occupied by the first time-frequency resource subset are time-domain resources in the first time-frequency-resource set located in the first time window.

In one embodiment, the phrase that the target time-frequency-resource pool comprises time-frequency resources belonging to a first time window in time domain comprised in the first time-frequency-resource set includes: time-domain resources occupied by the first time-frequency-resource set all belong to the first time window, and the target time-frequency-resource pool comprises the first time-frequency-resource set.

In one embodiment, the phrase that the target time-frequency-resource pool comprises time-frequency resources belonging to a second time window in time domain comprised in the second time-frequency-resource set includes: the target time-frequency-resource pool comprises a second time-frequency resource subset, the second time-frequency resource subset and the second time-frequency-resource set occupy same frequency-domain resources, a part of time-domain resources occupied by the second time-frequency resources belong to the second time window, and time-domain resources occupied by the second time-frequency resource subset are time-domain resources in the second time-frequency-resource set located in the second time window.

In one embodiment, the phrase that the target time-frequency-resource pool comprises time-frequency resources belonging to a second time window in time domain comprised in the second time-frequency-resource set includes: time-domain resources occupied by the second time-frequency-resource set all belong to the second time window, and the target time-frequency-resource pool comprises the second time-frequency-resource set.

In one embodiment, frequency-domain resources comprised in the target time-frequency-resource pool belong to unlicensed spectrum.

In one embodiment, a transmitter of the first information block is a second node, and the second node needs to perform channel monitoring before transmitting a radio signal in the target time-frequency-resource pool.

In one subembodiment of the above embodiment, the channel monitoring comprises LBT.

In one subembodiment of the above embodiment, the channel monitoring comprises channel sensing.

In one embodiment, frequency-domain resources occupied by the target time-frequency-resource pool are between 450 MHz to 6 GHz.

In one embodiment, frequency-domain resources occupied by the target time-frequency-resource pool are between 24.25 GHz to 52.6 GHz.

In one embodiment, the first node detects a physical-layer signaling in one of the X control channel candidates.

In one embodiment, the first node detects a physical-layer signaling in multiple of the X control channel candidates.

In one subembodiment of the above two embodiments, the physical-layer signaling comprises the target signaling in the present disclosure.

In one embodiment, the above phrase that the first time window is different from the second time window includes: there at least exists one OFDM symbol not belonging to the first time window and the second time window simultaneously.

In one embodiment, the above phrase that the first time window is different from the second time window includes: the first time window and the second time window are not overlapped in time domain.

### Embodiment 2

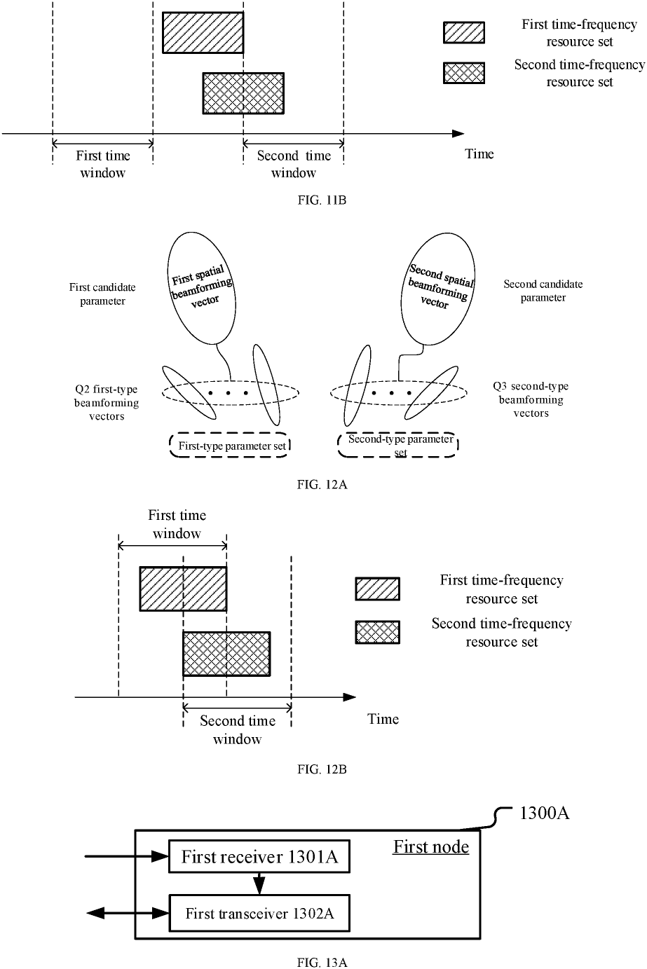

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise one or more UEs 201, an NG-RAN 202, an Evolved Packet Core/ 5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present disclosure can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/ Authentication Management Field(AMF)/ User Plane Function (UPF) 211, other MMEs/ AMFs/ UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present disclosure.

In one embodiment, the UE 201 supports wireless transmissions of Multi-Panel.

In one embodiment, the UE 201 supports wireless communications on unlicensed spectrum.

In one embodiment, the UE 201 supports simultaneous wireless communications on multiple beams.

In one embodiment, the gNB 203 corresponds to the second node in the present disclosure.

In one embodiment, the gNB 203 supports wireless transmissions of Multi-Panel.

In one embodiment, the gNB 203 supports wireless communications on unlicensed spectrum.

In one embodiment, the gNB 203 supports simultaneous wireless communications on multiple beams.

In one embodiment, an air interface between the UE 201 and the gNB 203 is a Uu interface.

In one embodiment, a radio link between the UE 201 and the gNB 203 is a cellular link.

In one embodiment, the first node in the present disclosure is a terminal within the coverage of the gNB 203.

### Embodiment 3

Embodiment 3 illustrates a schematic diagram of an example of a radio protocol architecture of a user plane and a control plane according to one embodiment of the present disclosure, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or RSU in V2X) and a second communication node (gNB, UE or RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present disclosure. The layer 2 (L2) 305 is above the PHY 301, and is in charge of the link between the first communication node and the second communication node via the PHY 301. L2 305 comprises a MAC sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The RRC sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the PDCP 304 of the second communication node is used to generate scheduling of the first communication node.

In one embodiment, the PDCP 354 of the second communication node is used to generate scheduling of the first communication node.

In one embodiment, the first information in the present disclosure is generated by the PHY 301 or the PHY 351.

In one embodiment, the first information in the present disclosure is generated by the MAC 302 or the MAC 352 .

In one embodiment, the first information in the present disclosure is generated by the RRC 306.

In one embodiment, the first-type signaling in the present disclosure is generated by the PHY 301 or the PHY 351.

In one embodiment, the target signaling in the present disclosure is generated by the PHY 301 or the PHY 351.

In one embodiment, the second information in the present disclosure is generated by the MAC 302 or the MAC 352 .

In one embodiment, the second information in the present disclosure is generated by the RRC 306.

In one embodiment, the first signaling in the present disclosure is generated by the PHY 301 or the PHY 351.

In one embodiment, the target signal in the present disclosure is generated by the MAC 302 or the MAC 352.

In one embodiment, the target signal in the present disclosure is generated by the RRC 306.

### Embodiment 4

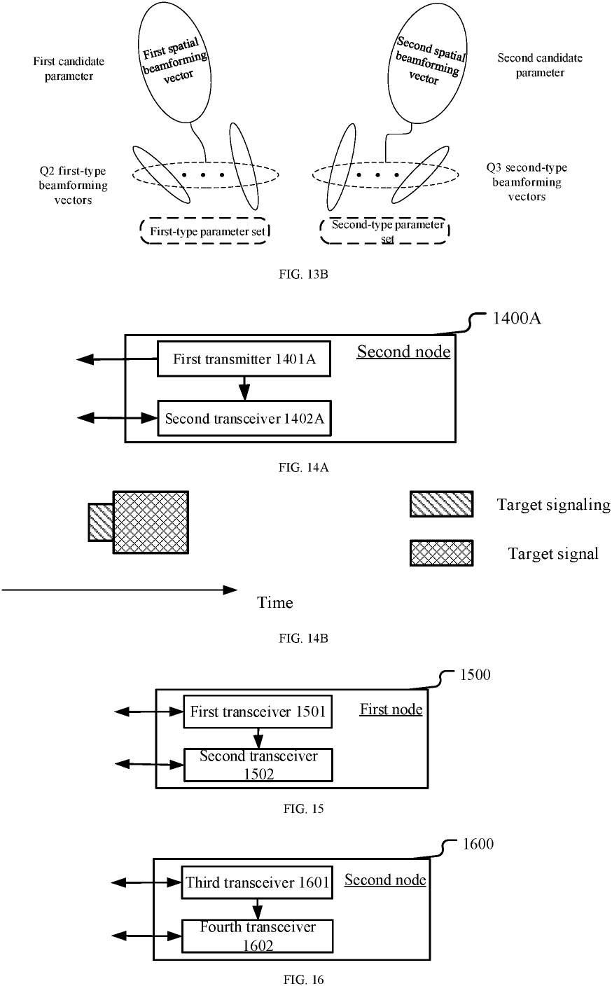

Embodiment 4 illustrates a schematic diagram of a first communication device and a second communication device in the present disclosure, as shown in FIG. 4. FIG. 4 is a block diagram of a first communication device 450 in communication with a second communication device 410 in an access network.

The first communication device 450 comprises a controller/ processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/ processor 475, a memory 476, a receiving processor 470, a transmitting processor 416, a multi-antenna receiving processor 472, a multi-antenna transmitting processor 471, a transmitter/ receiver 418 and an antenna 420.

In a transmission from the second communication device 410 to the first communication device 450, at the first communication device 410, a higher layer packet from the core network is provided to a controller/ processor 475. The controller/processor 475 provides a function of the L2 layer. In the transmission from the second communication device 410 to the first communication device 450, the controller/ processor 475 provides header compression, encryption, packet segmentation and reordering, and multiplexing between a logical channel and a transport channel, and radio resources allocation for the first communication device 450 based on various priorities. The controller/ processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/ processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410,the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor, the first communication device 450 at least receives first information, and monitors a first-type signaling in a first time-frequency-resource pool; the first information is used to determine a first candidate parameter and a second candidate parameter; a target parameter is the first candidate parameter, or a target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

In one embodiment, the first communication device 450 comprises at least one processor and at least one memory. a memory that stores a computer readable instruction program. The computer readable instruction program generates an action when executed by at least one processor. The action includes: receiving first information, and monitoring a first-type signaling in a first time-frequency-resource pool; the first information is used to determine a first candidate parameter and a second candidate parameter; a target parameter is the first candidate parameter, or a target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits first information, and transmits a first-type signaling in a first time-frequency-resource pool; the first information is used to determine a first candidate parameter and a second candidate parameter; a target parameter is the first candidate parameter, or the target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

In one embodiment, the second communication device 410 comprises a memory that stores a computer readable instruction program. The computer readable instruction program generates an action when executed by at least one processor. The action includes: transmitting first information, and transmitting a first-type signaling in a first time-frequency-resource pool; the first information is used to determine a first candidate parameter and a second candidate parameter; a target parameter is the first candidate parameter, or the target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

In one embodiment, the first communication device 450 comprises at least one processor and at least one memory. The at least one memory comprises computer program codes; the at least one memory and the computer program codes are configured to be used in collaboration with the at least one processor, the first communication device 450 at least receives a first information block; and monitors X control channel candidates in a target time-frequency-resource pool, the X being a positive integer greater than 1; the first information block is used to indicate a first time-frequency-resource set and a second time-frequency-resource set; the target time-frequency-resource pool comprises time-frequency resources belonging to a first time window in time domain comprised in the first time-frequency-resource set, and the target time-frequency-resource pool comprises time-frequency resources belonging to a second time window in time domain comprised in the second time-frequency-resource set; the first time window is different from the second time window, and a relative position relation between the first time window and the second time window is used to determine time-frequency distribution of the X control channel candidates in the target time-frequency-resource pool.

In one embodiment, the first communication device 450 comprises at least one processor and at least one memory. a memory that stores a computer readable instruction program. The computer readable instruction program generates an action when executed by at least one processor. The action includes: receiving a first information block; and monitoring X control channel candidates in a target time-frequency-resource pool, the X being a positive integer greater than 1; the first information block is used to indicate a first time-frequency-resource set and a second time-frequency-resource set; the target time-frequency-resource pool comprises time-frequency resources belonging to a first time window in time domain comprised in the first time-frequency-resource set, and the target time-frequency-resource pool comprises time-frequency resources belonging to a second time window in time domain comprised in the second time-frequency-resource set; the first time window is different from the second time window, and a relative position relation between the first time window and the second time window is used to determine time-frequency distribution of the X control channel candidates in the target time-frequency-resource pool.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first information block, and transmits a target signaling in a target time-frequency-resource pool; the target time-frequency-resource pool comprises X control channel candidates, the X being a positive integer greater than 1; the target signaling occupies one of the X control channel candidates; the first information block is used to indicate a first time-frequency-resource set and a second time-frequency-resource set; the target time-frequency-resource pool comprises time-frequency resources belonging to a first time window in time domain comprised in the first time-frequency-resource set, and the target time-frequency-resource pool comprises time-frequency resources belonging to a second time window in time domain comprised in the second time-frequency-resource set; the first time window is different from the second time window, and a relative position relation between the first time window and the second time window is used to determine time-frequency distribution of the X control channel candidates in the target time-frequency-resource pool.

In one embodiment, the second communication device 410 comprises a memory that stores a computer readable instruction program. The computer readable instruction program generates an action when executed by at least one processor. The action includes: transmitting a first information block, and transmitting a target signaling in a target time-frequency-resource pool; the target time-frequency-resource pool comprises X control channel candidates, the X being a positive integer greater than 1; the target signaling occupies one of the X control channel candidates; the first information block is used to indicate a first time-frequency-resource set and a second time-frequency-resource set; the target time-frequency-resource pool comprises time-frequency resources belonging to a first time window in time domain comprised in the first time-frequency-resource set, and the target time-frequency-resource pool comprises time-frequency resources belonging to a second time window in time domain comprised in the second time-frequency-resource set; the first time window is different from the second time window, and a relative position relation between the first time window and the second time window is used to determine time-frequency distribution of the X control channel candidates in the target time-frequency-resource pool.

In one embodiment, the first communication device 450 corresponds to a first node in the present disclosure.

In one embodiment, the second communication device 410 corresponds to a second node in the present disclosure.

In one embodiment, the first communication device 450 is a UE.

In one embodiment, the first communication device 450 is a terminal.

In one embodiment, the second communication device 410 is a base station.

In one embodiment, the second communication device 410 is a network device.

In one embodiment, at least first four of the antenna 452, the receiver 454, the multi-antenna receiving processor 458, the receiving processor 456 and the controller/processor 459 are used to receive first information; at least first four of the antenna 420, the transmitter 418, the multi-antenna transmitting processor 471, the transmitting processor 416 and the controller/processor 475 are used to transmit first information.

In one embodiment, at least first four of the antenna 452, the receiver 454, the multi-antenna receiving processor 458, the receiving processor 456 and the controller/processor 459 are used to monitor a first-type signaling in a first time-frequency-resource pool; at least first four of the antenna 420, the transmitter 418, the multi-antenna transmitting processor 471, the transmitting processor 416 and the controller/processor 475 are used to transmit a first-type signaling in a first time-frequency-resource pool.

In one embodiment, at least first four of the antenna 452, the receiver 454, the multi-antenna receiving processor 458, the receiving processor 456 and the controller/processor 459 are used to receive a target signaling; at least first four of the antenna 420, the transmitter 418, the multi-antenna transmitting processor 471, the transmitting processor 416 and the controller/processor 475 are used to transmit a target signaling.

In one embodiment, at least first four of the antenna 452, the receiver 454, the multi-antenna receiving processor 458, the receiving processor 456 and the controller/processor 459 are used to receive second information; at least first four of the antenna 420, the transmitter 418, the multi-antenna transmitting processor 471, the transmitting processor 416 and the controller/processor 475 are used to transmit second information.

In one embodiment, at least first four of the antenna 452, the receiver 454, the multi-antenna receiving processor 458, the receiving processor 456 and the controller/processor 459 are used to receive first signaling; at least first four of the antenna 420, the transmitter 418, the multi-antenna transmitting processor 471, the transmitting processor 416 and the controller/processor 475 are used to transmit a first signaling.

In one embodiment, at least first four of the antenna 452, the receiver 454, the multi-antenna receiving processor 458, the receiving processor 456 and the controller/processor 459 are used to receive a target signal; at least first four of the antenna 420, the transmitter 418, the multi-antenna transmitting processor 471, the transmitting processor 416 and the controller/processor 475 are used to transmit a target signal.

In one embodiment, at least first four of the antenna 452, the transmitter 454, the multi-antenna transmitting processor 457, the transmitting processor 468, and the controller/processor 459 are used to transmit a target signal; at least first four of the antenna 420, the receiver 418, the multi-antenna receiving processor 472, the receiving processor 470 and the controller/processor 475 are used to receive a target signal.

In one embodiment, at least first four of the antenna 452, the receiver 454, the multi-antenna receiving processor 458, the receiving processor 456 and the controller/processor 459 are used to receive a first information block; at least first four of the antenna 420, the transmitter 418, the multi-antenna transmitting processor 471, the transmitting processor 416 and the controller/processor 475 are used to transmit a first information block.

In one embodiment, at least first four of the antenna 452, the receiver 454, the multi-antenna receiving processor 458, the receiving processor 456 and the controller/processor 459 are used to monitor X control channel candidates in a target time-frequency-resource pool, X being a positive integer greater than 1.

In one embodiment, at least first four of the antenna 420, the transmitter 418, the multi-antenna transmitting processor 471, the transmitting processor 416 and the controller/processor 475 are used to transmit a target signaling in a target time-frequency-resource pool.

In one embodiment, at least first four of the antenna 452, the transmitter 454, the multi-antenna transmitting processor 457, the transmitting processor 468, and the controller/processor 459 are used to transmit target information; at least first four of the antenna 420, the receiver 418, the multi-antenna receiving processor 472, the receiving processor 470 and the controller/processor 475 are used to receive target information.

In one embodiment, at least first four of the antenna 452, the receiver 454, the multi-antenna receiving processor 458, the receiving processor 456 and the controller/processor 459 are used to receive first signaling; at least first four of the antenna 420, the transmitter 418, the multi-antenna transmitting processor 471, the transmitting processor 416 and the controller/processor 475 are used to transmit a first signaling.

In one embodiment, at least first four of the antenna 452, the receiver 454, the multi-antenna receiving processor 458, the receiving processor 456 and the controller/processor 459 are used to receive a second signaling; at least first four of the antenna 420, the transmitter 418, the multi-antenna transmitting processor 471, the transmitting processor 416 and the controller/processor 475 are used to transmit a second signaling.

In one embodiment, at least first four of the antenna 452, the receiver 454, the multi-antenna receiving processor 458, the receiving processor 456 and the controller/processor 459 are used to receive a target signaling in a first control channel candidate.

In one embodiment, at least first four of the antenna 420, the transmitter 418, the multi-antenna transmitting processor 471, the transmitting processor 416 and the controller/processor 475 are used to determine a first control channel candidate.

In one embodiment, at least first four of the antenna 452, the receiver 454, the multi-antenna receiving processor 458, the receiving processor 456 and the controller/processor 459 are used to receive a target signal in a target time-frequency-resource block; at least first four of the antenna 420, the transmitter 418, the multi-antenna transmitting processor 471, the transmitting processor 416 and the controller/processor 475 are used to transmit a target signal in a target time-frequency-resource block.

In one embodiment, at least first four of the antenna 452, the transmitter, the multi-antenna transmitting processor 457, the transmitting processor 468, and the controller/processor 459 are used to transmit a target signal in a target time-frequency-resource block; at least first four of the antenna 420, the receiver 418, the multi-antenna receiving processor 472, the receiving processor 470 and the controller/processor 475 are used to receive a target signal in a target time-frequency-resource block.

### Embodiment 5A

Embodiment 5A illustrates a flowchart of first information, as shown in FIG. 5A. In FIG. 5A, a first node U1A and a second node N2A are in communications via a radio link. It is particularly underlined that the order illustrated in the embodiment does not put constraints over sequences of signal transmissions and implementations.

The first node U1A receives second information in step S10A, receives first information in step S11A, receives a target signaling in step S12A, and monitors a first-type signaling in a first time-frequency-resource pool in step S13A.

The second node N2A transmits second information in step S20A, transmits first information in step S21A, transmits a target signaling in step S22A, and transmits a first-type signaling in a first time-frequency-resource pool in step S23A.

In embodiment 5A, the first information is used to determine a first candidate parameter and a second candidate parameter; a target parameter is the first candidate parameter, or a target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1; the second information is used to indicate M1 candidate parameters, M1 being a positive integer greater than 1, and the first candidate parameter is one of the M1 candidate parameters; the target signaling is used to determine the first time window.

In one embodiment, a MAC CE bearing the first information is a UE-Specific PDCCH MAC CE.

In one embodiment, the first information comprises 24 bits.

In one embodiment, the first information comprises the first candidate parameter and the second candidate parameter, and the first information is used to indicate the first time-frequency-resource pool.

In one subembodiment of the above embodiment, the first information comprises a first field and a second field, the first field is used to indicate the first candidate parameter, and the second field is used to indicate the second candidate parameter.

In one subembodiment of the above embodiment, the first information comprises a third field, and the third field is used to indicate the first time-frequency-resource pool.

In one subembodiment of the above embodiment, the first information indicates a position of time-domain resources occupied by the first time-frequency-resource pool.

In one subembodiment of the above embodiment, the first information indicates a position of frequency-domain resources occupied by the first time-frequency-resource pool.

In one subembodiment of the above embodiment, the first information indicates a position of RE occupied by the first time-frequency-resource pool.

In one embodiment, the first information comprises 16 bits.

In one embodiment, the first information only comprises one of the first candidate parameter or the second candidate parameter, one of the first candidate parameter or the second candidate parameter that is not comprised in the first information is configured via a higher-layer signaling, and the higher-layer signaling is used to indicate that the first candidate parameter is associated with the second candidate parameter.

In one subembodiment of the above embodiment, the first information is only used to indicate the first candidate parameter, and the higher-layer signaling is used to indicate that the first candidate parameter is associated with the second candidate parameter.

In one subembodiment of the above embodiment, the first information is only used to indicate the second candidate parameter, and the higher-layer signaling is used to indicate that the first candidate parameter is associated with the second candidate parameter.

In one embodiment, the target signaling is a physical-layer signaling.

In one embodiment, the target signaling is cell-specific.

In one embodiment, the target signaling UE-specific.

In one embodiment, the target signaling comprises a CRC, and the CRC comprised in the target signaling is scrambled by a Common Control Radio Network Temporary Identifier (CC-RNTI).

In one embodiment, the target signaling comprises a CRC, the CRC comprised in the target signaling is scrambled by an RNTI other than a UE-specific RNTI.

In one embodiment, the target signaling is used to indicate the first time window.

In one embodiment, the target signaling is used to indicate a second time window, and the second time window is used to determine the first time window; the second time window comprises at least one slot in time domain.

In one subembodiment of the above embodiment, the second time window comprises at least one consecutive slot in time domain.

In one subembodiment of the above embodiment, the first time window belongs to the second time window.

In one subembodiment of the above embodiment, an end time of the second time window is used to determine an end time of the first time window.

In one embodiment, the first time window comprises at least one slot in time domain.

In one embodiment, the target signaling is used to indicate a start time of the first time window in time domain.

In one embodiment, the target signaling is used to indicate a duration of the first time window in time domain.

In one embodiment, the first node receives the target signaling in a first slot, and the first node assumes that the first time window starts from the first slot.

In one embodiment, the first time window is a COT.

In one embodiment, a transmitter of the target signaling determines a start time of the first time window through LBT.

In one embodiment, a transmitter of the target signaling determines a start time of the first time window through channel sensing.

In one embodiment, a last OFDM symbol occupied by the target signaling is used to determine a start time of the first time window.

In one embodiment, the target signaling and the first-type signaling are transmitted by the second node N2 on different BWPs respectively.

In one embodiment, the target signaling and the first-type signaling are received by the first node U1 on different BWPs respectively.

In one embodiment, the target signaling and the first-type signaling are transmitted by the second node N2 on different subbands respectively.

In one embodiment, the target signaling and the first-type signaling are received by the first node U1 on different subbands respectively.

In one embodiment, the target signaling and the first-type signaling are transmitted by the second node N2 on different carriers respectively.

In one embodiment, the target signaling and the first-type signaling are received by the first node U1 on different carriers respectively.

In one embodiment, the M1 candidate parameters are all associated with the first time-frequency-resource pool.

In one embodiment, the second candidate parameter is one of the M1 candidate parameters.

In one embodiment, any of the M1 candidate parameters is a TCI-State.

In one embodiment, any of the M1 candidate parameters is a TCI-StateID.

In one embodiment, any of the M1 candidate parameters corresponds to at least one given candidate signal, and the given candidate signal comprises a CSI-RS.

In one embodiment, any of the M1 candidate parameters corresponds to at least one given candidate signal, and the given candidate signal comprises an SSB.

In one embodiment, any of the M1 candidate parameters corresponds to at least one given candidate signal, and the given candidate signal is transmitted on a CSI-RS resource.

In one embodiment, any of the M1 candidate parameters corresponds to at least one given candidate signal, and the given candidate signal is transmitted on an SSB resource.

In one embodiment, the second information comprises one or more fields in a ControlResourceSet in TS 38.331.

In one embodiment, a ControlResourceSet in TS 38.331 comprises the second information.

In one embodiment, the second information comprises one or more fields in a SearchSpace in TS 38.331.

In one embodiment, a SearchSpace in TS 38.331 comprises the second information.

### Embodiment 5B

Embodiment 5B illustrates a flowchart of first information, as shown in FIG. 5B. In FIG. 5B, a first node U1B and a second node N2B are in communications via a radio link. It is particularly underlined that the order illustrated in the embodiment does not put constraints over sequences of signal transmissions and implementations.

The first node U1B transmits target information in step S10B, receives a first information block in step S11B, monitors X control channel candidates in a target time-frequency-resource pool in step S12B, and receives a target signaling in a first control channel candidate in step S13B.

The second node N2B receives target information in step S20B, transmits a first information block in step S21B, determines a first control channel candidate in step S22B, and transmits a target signaling in a target time-frequency-resource pool in step S23B.

In Embodiment 5B, the X is a positive integer greater than 1; the first information block is used to indicate a first time-frequency-resource set and a second time-frequency-resource set; the target time-frequency-resource pool comprises time-frequency resources belonging to a first time window in time domain comprised in the first time-frequency-resource set, and the target time-frequency-resource pool comprises time-frequency resources belonging to a second time window in time domain comprised in the second time-frequency-resource set; the first time window is different from the second time window, and a relative position relation between the first time window and the second time window is used to determine time-frequency distribution of the X control channel candidates in the target time-frequency-resource pool; the first control channel candidate is one of the X control channel candidates; the target signaling occupies the first control channel candidate; the target information is used to indicate that the first node U1B supports M1 control resource set pools, M1 being a positive integer greater than 1; the first time-frequency-resource set and the second time-frequency-resource set respectively belong to two different control resource set pools in the K1 control resource set pools.

In one embodiment, the above phrase of determining a first control channel candidate includes determining a position of the first control channel candidate among the X control channel candidates.

In one embodiment, the above phrase of determining a first control channel candidate includes determining which of the X control channel candidates is the first control channel candidate.

In one embodiment, the above phrase of determining a first control channel candidate includes determining a time-frequency position of the first control channel candidate.

In one embodiment, the above phrase of determining a first control channel candidate includes determining an aggregation level adopted by the target signaling.

In one embodiment, the first time-frequency-resource set and the second time-frequency-resource set are respectively associated with a first candidate parameter and a second candidate parameter; the first candidate parameter is used for receiving a signal in the first time-frequency-resource set, and the second candidate parameter is used for receiving a signal in the second time-frequency-resource set.

In one subembodiment of the above embodiment, the first information block is used to explicitly indicate the first candidate parameter, and the first candidate parameter is associated with the first time-frequency-resource set.

In one subembodiment of the above embodiment, the first information block is used to explicitly indicate the second candidate parameter, and the second candidate parameter is associated with the second time-frequency-resource set.

In one subembodiment of the above embodiment, the first candidate parameter is a TCI-State.

In one subembodiment of the above embodiment, the first candidate parameter corresponds to a TCI-StateID.

In one subembodiment of the above embodiment, the first candidate parameter corresponds to a first candidate signal.

In one subsidiary embodiment of the subembodiment, the first candidate signal comprises CSI-RS.

In one subsidiary embodiment of the subembodiment, the first candidate signal comprises an SSB.

In one subsidiary embodiment of the subembodiment, the first candidate signal is transmitted on a CSI-RS resource.

In one subsidiary embodiment of the subembodiment, the first candidate signal is transmitted on an SSB resource.

In one subembodiment of the above embodiment, the second candidate parameter is a TCI-State.

In one subembodiment of the above embodiment, the second candidate parameter corresponds to a TCI-StateID.

In one subembodiment of the above embodiment, the second candidate parameter corresponds to a second candidate signal.

In one subsidiary embodiment of the subembodiment, the second candidate signal comprises a CSI-RS.

In one subsidiary embodiment of the subembodiment, the second candidate signal comprises an SSB.

In one subsidiary embodiment of the subembodiment, the second candidate signal is transmitted on a CSI-RS resource.

In one subsidiary embodiment of the subembodiment, the second candidate signal is transmitted on an SSB resource.

In one subembodiment of the above embodiment, the above phrase that the first candidate parameter is used for receiving a signal in the first time-frequency-resource set includes: the first candidate parameter is used to determine a Spatial Rx parameter of the signal in the first time-frequency-resource set.

In one subembodiment of the above embodiment, the above phrase that the first candidate parameter is used for receiving a signal in the first time-frequency-resource set includes: the first candidate parameter is used to indicate a first reference signal, and a spatial Rx parameter of the first reference signal is used to determine a Spatial Rx parameter of the signal in the first time-frequency-resource set.

In one subembodiment of the above embodiment, the above phrase that the first candidate parameter is used for receiving a signal in the first time-frequency-resource set includes: the first candidate parameter is used to indicate a first reference signal, and the first reference signal and the signal in the first time-frequency-resource set are QCL.

In one subembodiment of the above embodiment, the above phrase that the second candidate parameter is used for receiving a signal in the second time-frequency-resource set includes: the second candidate parameter is used to determine a Spatial Rx Parameter of the signal in the second time-frequency-resource set.

In one subembodiment of the above embodiment, the above phrase that the second candidate parameter is used for receiving a signal in the second time-frequency-resource set includes: the second candidate parameter is used to indicate a second reference signal, and a Spatial Rx Parameter of the second reference signal is used to determine a Spatial Rx Parameter of the signal in the second time-frequency-resource set.

In one subembodiment of the above embodiment, the above phrase that the second candidate parameter is used for receiving a signal in the second time-frequency-resource set includes: the second candidate parameter is used to indicate a second reference signal, and the second reference signal and the signal in the second time-frequency-resource set are QCL.

In one subembodiment of the above embodiment, a reception of a signal in the first time-frequency-resource set includes a blind detection performed on one of the X control channel candidates located in the first time-frequency-resource set.

In one subembodiment of the above embodiment, a reception of a signal in the second time-frequency-resource set includes a blind detection performed on one of the X control channel candidates located in the second time-frequency-resource set.

In one embodiment, the first time window and the second time window are overlapped in time domain, there at least exists one of the X control channel candidates belonging to the first time-frequency-resource set, and there at least exists another one of the X control channel candidates belonging to the second time-frequency-resource set.

In one subembodiment of the above embodiment, the above phrase that the first time window and the second time window are overlapped in time domain includes: the first time window and the second time window at least comprise a same OFDM symbol in time domain.

In one subembodiment of the above embodiment, the above phrase that the first time window and the second time window are overlapped in time domain includes: the first time window and the second time window are both a same slot.

In one subembodiment of the above embodiment, the first time window and the second time window are overlapped in time domain, the X control channel candidates are distributed in time-frequency resources belonging to a first time window in time domain comprised in the first time-frequency-resource set and in time-frequency resources belonging to a second time window in time domain comprised in the second time-frequency-resource set.

In one subembodiment of the above embodiment, the first time window and the second time window are overlapped in time domain, the first node blindly detects the X control signaling candidates in a first time-frequency resource subset and a second time-frequency resource subset, the first time-frequency resource subset is a part of time-frequency resources belonging to a first time window in time domain comprised in the first time-frequency-resource set, and the second time-frequency resource subset is a part of time-frequency resources belonging to a second time window in time domain comprised in the second time-frequency-resource set.

In one embodiment, the first time window and the second time window are orthogonal in time domain; any of the X control channel candidates belongs to a first time-frequency resource subset, or any of the X control channel candidates belongs to a second time-frequency resource subset; the first time-frequency resource subset is time-frequency resources belonging to a first time window in time domain comprised in the first time-frequency-resource set, and the second time-frequency resource subset is time-frequency resources belonging to a second time window in time domain comprised in the second time-frequency-resource set.

In one subembodiment of the above embodiment, the above phrase that the first time window and the second time window are orthogonal in time domain includes: there exists no OFDM symbol belonging to the first time window and the second time window simultaneously.

In one subembodiment of the above embodiment, the first time window belongs to a COT, the second time window does not belong to a COT, and any of the X control channel candidates belongs to the first time-frequency resource subset.

In one subembodiment of the above embodiment, the first time window does not belong to a COT, the second time window belongs to a COT, and any of the X control channel candidates belongs to the second time-frequency resource subset.

In one subembodiment of the above embodiment, the first time window is earlier than the second time window in time domain, and any of the X control channel candidates belongs to the first time-frequency resource subset.

In one subembodiment of the above embodiment, the first time window is later than the second time window in time domain, and any of the X control channel candidates belongs to the second time-frequency resource subset.

In one subembodiment of the above embodiment, when any of the X control channel candidates belongs to the first time-frequency resource subset, the first node U1B does not perform a blind detection on the X control signaling candidates in the second time-frequency-resource set.

In one subembodiment of the above embodiment, when any of the X control channel candidates belongs to the second time-frequency resource subset, the first node U1B does not perform a blind detection on the X control signaling candidates in the first time-frequency-resource set.

In one subembodiment of the above embodiment, when any of the X control channel candidates belongs to the first time-frequency resource subset, the first node U1B does not perform a blind detection on the X control signaling candidates in the second time-frequency-resource set.

In one embodiment, the first time-frequency-resource set is configured with K1 control channel candidates, the second time-frequency-resource set is configured with K2 control channel candidates, a sum of the K1 and the K2 is greater than the X, and the K1 and the K2 are positive integers greater than 1; X1 control channel candidate(s) out of the K1 control channel candidates belongs(belong) to the X control channel candidates, and X2 control channel candidate(s) out of the K2 control channel candidates belongs(belong) to the X control channel candidates; a sum of the X1 and the X2 is equal to the X; a sum of the K1 and the K2 is equal to K, and the X1 is linearly related to a ratio of the K1 to the K, and the X2 is linearly related to a ratio of the K2 to the K.

In one subembodiment of the above embodiment, the X1 is less than the K1.

In one subembodiment of the above embodiment, the X1 is not greater than the K1.

In one subembodiment of the above embodiment, the X2 is less than the K2.

In one subembodiment of the above embodiment, the X2 is not greater than the K2.

In one subembodiment of the above embodiment, the first time-frequency-resource set is configured with the K1 control channel candidates via an RRC signaling.

In one subembodiment of the above embodiment, the second time-frequency-resource set is configured with the K2 control channel candidates via an RRC signaling.

In one subembodiment of the above embodiment, the X1 is equal to an integer part of K1*X/K.

In one subembodiment of the above embodiment, the X1 is not greater than K1*X/K.

In one subembodiment of the above embodiment, the X2 is equal to an integer part of K2*X/K.

In one subembodiment of the above embodiment, the X2 is not greater than K2*X/K.

In one subembodiment of the above embodiment, the K1 control channel candidates are indexed in order, and the X1 control channel candidate(s) is(are) X1 control channel candidate(s) with smaller index(es) among the K1 control channel candidates.

In one subembodiment of the above embodiment, the K1 control channel candidates comprise K1_L control channel candidate(s) with an aggregation level equal to L, the L is equal to one of 1, 2, 4, 8, or 16, the K1_L is a positive integer not greater than the K1, M1_L control channel candidate(s) in the K1_L control channel candidate(s) belongs(belong to) to the X1 control channel candidate(s), the M1_L is a maximum integer not greater than (K1_L*K1/K).

In one subembodiment of the above embodiment, the K2 control channel candidates are indexed in order, and the X2 control channel candidate(s) is(are) X2 control channel candidate(s) with smaller index(es) among the K2 control channel candidates.

In one subembodiment of the above embodiment, the K2 control channel candidates comprise K2_L control channel candidate(s) with an aggregation level equal to L, the L is equal to one of 1, 2, 4, 8, or 16, the K2_L is a positive integer not greater than the K2, M2_L control channel candidate(s) in the K2_L control channel candidate(s) belongs(belong to) to the X2 control channel candidate(s), the M2_L is a maximum integer not greater than (K2_L*K2/K).

In one embodiment, the M1 is equal to 2.

In one embodiment, the M1 control resource set pool(s) is(are respectively) M1 CORESET Pool(s).

In one embodiment, the first node comprises M1 panel(s), and the M1 panel(s) corresponds(respectively correspond) to the M1 control resource pool(s).

In one embodiment, the target information is carried via an RRC signaling.

In one embodiment, the target information is used to indicate a multi-antenna capability of the first node U1B.

In one embodiment, the target information comprises all or part of fields in a UE-NR-Capability in TS 38.331.

In one embodiment, the first time window comprises time-domain resources occupied by the first time-frequency-resource set, and the first time-frequency-resource set is equal to the first time-frequency resource subset.

In one embodiment, the second time window comprises time-domain resources occupied by the second time-frequency-resource set, and the second time-frequency-resource set is equal to the second time-frequency resource subset.

### Embodiment 6A

Embodiment 6A illustrates a flowchart of a target signal, as shown in FIG. 6A. In FIG. 6A, a first node U3A and a second node N4A are in communications via a radio link. It is particularly underlined that the order illustrated in the embodiment does not put constraints over sequences of signal transmissions and implementations. Embodiments and sub-embodiments in Embodiment 6A can be applied to Embodiment 5A if no conflict is incurred; and vice versa, embodiments and sub-embodiments in Embodiment 5A can be applied to Embodiment 6A if no conflict is incurred.

The first node U3A receives a first signaling in a first RE set in step S30A, and receives a target signal in a target time-frequency-resource block in step S31A.

The second node N4A transmits a first signaling in a first RE set in step S40A, and transmits a target signal in a target time-frequency-resource block in step S41A.

In Embodiment 6A, the first RE set is one of the K1 RE sets, and the first signaling is the first-type signaling; the first signaling is used to indicate the target time-frequency-resource block; the first signaling is used to indicate a first parameter out of a first parameter set, the first parameter is used for receiving the target signal, and the first parameter set is one of a first-type parameter set or a second-type parameter set; whether the first time-frequency-resource pool belongs to the first time window in time domain is used to determine whether the first parameter set is the first-type parameter set or the second-type parameter set.

In one embodiment, the first signaling is used to indicate frequency-domain resources occupied by the target time-frequency-resource block.

In one embodiment, the first signaling is used to indicate time-domain resources occupied by the target time-frequency-resource block.

In one embodiment, the first signaling is used to indicate an RE occupied by the target time-frequency-resource block.

In one embodiment, the target time-frequency-resource block occupies more than one REs.

In one embodiment, the first RE set is a PDCCH candidate.

In one embodiment, the first signaling is a physical-layer signaling.

In one embodiment, a physical-layer channel occupied by the first signaling is a PDCCH.

In one embodiment, the first signaling is a piece of DCI.

In one embodiment, the first signaling is a downlink grant.

In one embodiment, a physical-layer channel occupied by the target signal is a PDSCH.

In one embodiment, a transmission channel occupied by the target signal is a Downlink Shared Channel (DL-SCH).

In one embodiment, a physical-layer channel occupied by the first signaling is a PSCCH.

In one embodiment, the first signaling is a piece of Sidelink Control Information (SCI).

In one embodiment, a physical-layer channel occupied by the target signal is a Physical Sidelink Shared Channel (PSSCH).

In one embodiment, a transmission channel occupied by the target signal is a Sidelink Shared Channel (SL-SCH).

In one embodiment, the first signaling is used to schedule the target signal.

In one embodiment, the above phrase that the first parameter is used for receiving the target signal includes: the first parameter is used to determine a Spatial Rx Parameter of the target signal.

In one embodiment, the above phrase that the first parameter is used for receiving the target signal includes: the first parameter is used to indicate a first reference signal, and a Spatial Rx Parameter of the first reference signal is used to determine a Spatial Rx Parameter of the target signal.

In one embodiment, the above phrase that the first parameter is used for receiving the target signal includes: the first parameter is used to indicate a first reference signal, and the first reference signal and the target signal are QCL.

In one subembodiment of the above two embodiments, the first reference signal comprises a CSI-RS.

In one subembodiment of the above two embodiments, the first reference signal comprises an SSB.

In one subembodiment of the above two embodiments, the first reference signal is transmitted on a CSI-RS resource.

In one subembodiment of the above two embodiments, the first reference signal is transmitted on an SSB resource.

In one embodiment, the QCL in the present disclosure is one of QCL-TypeA, QCL-TypeB, QCL-TypeC, or QCL-TypeD in TS 38.214.

In one embodiment, the first parameter set comprises Q1 parameters, the first parameter is a parameter in the first parameter set, and the Q1 is a positive integer greater than 1.

In one subembodiment of the above embodiment, any of the Q1 parameters is a TCI-State.

In one subembodiment of the above embodiment, any of the Q1 parameters corresponds to a TCI-StateID.

In one subembodiment of the above embodiment, any of the Q1 parameters corresponds to a radio signal, and the radio signal comprises a CSI-RS.

In one subembodiment of the above embodiment, any of the Q1 parameters corresponds to a radio signal, and the radio signal is transmitted in a CSI-RS resource.

In one subembodiment of the above embodiment, any of the Q1 parameters corresponds to a radio signal, and the radio signal comprises an SSB.

In one subembodiment of the above embodiment, any of the Q1 parameters corresponds to a radio signal, and the radio signal is transmitted in an SSB resource.

In one embodiment, the first time-frequency pool belongs to the first time window in time domain, and the first parameter set is the first-type parameter set.

In one embodiment, the first time-frequency pool does not belong to the first time window in time domain, and the first parameter set is the second-type parameter set.

In one embodiment, the first-type parameter set comprises Q2 first-type parameters, and the Q2 is a positive integer greater than 1.

In one subembodiment of the above embodiment, any of the Q2 first-type parameters is a TCI-State.

In one subembodiment of the above embodiment, any of the Q2 first-type parameters corresponds to a TCI-StateID.

In one subembodiment of the above embodiment, any of the Q2 first-type parameters corresponds to a radio signal, and the radio signal comprises a CSI-RS.

In one subembodiment of the above embodiment, any of the Q2 first-type parameters corresponds to a radio signal, and the radio signal is transmitted in a CSI-RS resource.

In one subembodiment of the above embodiment, any of the Q2 first-type parameters corresponds to a radio signal, and the radio signal comprises an SSB.

In one subembodiment of the above embodiment, any of the Q2 first-type parameters corresponds to a radio signal, and the radio signal is transmitted in an SSB.

In one subembodiment of the above embodiment, the Q2 is equal to the Q1, and the Q2 first-type parameters are respectively Q1 parameters comprised in the first parameter set.

In one embodiment, the second-type parameter set comprises Q3 second-type parameters, and the Q3 is a positive integer greater than 1.

In one subembodiment of the above embodiment, any of the Q3 second-type parameters is a TCI-State.

In one subembodiment of the above embodiment, any of the Q3 second-type parameters corresponds to a TCI-StateID.

In one subembodiment of the above embodiment, any of the Q3 second-type parameters corresponds to a radio signal, and the radio signal comprises a CSI-RS.

In one subembodiment of the above embodiment, any of the Q3 second-type parameters corresponds to a radio signal, and the radio signal is transmitted in a CSI-RS resource.

In one subembodiment of the above embodiment, any of the Q3 second-type parameters corresponds to a radio signal, and the radio signal comprises an SSB.

In one subembodiment of the above embodiment, any of the Q3 second-type parameters corresponds to a radio signal, and the radio signal is transmitted in an SSB.

In one subembodiment of the above embodiment, the Q3 is equal to the Q1, and the Q3 second-type parameters are respectively Q1 parameters comprised in the first parameter set.

In one embodiment, the target signal is a radio signal.

In one embodiment, the target signal is a baseband signal.

In one embodiment, the first-type parameter set is configured via an RRC signaling.

In one embodiment, the second-type parameter set is configured via an RRC signaling.

In one embodiment, the first-type parameter and the second-type parameter set are configured on a data channel scheduled by the first time-frequency-resource pool via an RRC signaling.

In one embodiment, the first-type parameter set and the second-type parameter set are configured through one or more fields in PDSCH-config in TS 38.331.

In one embodiment, the first-type parameter set and the second-type parameter set are configured through one or more fields in PUSCH-config in TS 38.331.

### Embodiment 6B

Embodiment 6B illustrates a flowchart of a target signal, as shown in FIG. 6B. In FIG. 6B, a first node U3B and a second node N4B are in communications via a radio link. It is particularly underlined that the order illustrated in the embodiment does not put constraints over sequences of signal transmissions and implementations. Embodiments and sub-embodiments in Embodiment 6B can be applied to Embodiments 5B, 7B and 8B if no conflict is incurred; and vice versa, embodiments, sub-embodiments and subsidiary embodiments in Embodiments 5B, 7B and 8B can be applied to Embodiment 6B if no conflict is incurred.

The first node U3B receives a target signal in a target time-frequency-resource block in step S30B.

The second node N4B transmits a target signal in a target time-frequency-resource block in step S40B.

In Embodiment 6B, the target signaling is used to indicate the target time-frequency-resource block.

In one embodiment, the target signaling is a physical-layer signaling.

In one embodiment, a physical-layer channel occupied by the target signaling is a PDCCH.

In one embodiment, the target signaling is a piece of DCI.

In one embodiment, the target time-frequency-resource pool comprises Y1 CCEs, any of the X control channel candidates occupies one or more CCEs, the Y1 being a positive integer greater than 1.

In one embodiment, the target signaling is a downlink grant.

In one embodiment, a physical-layer channel occupied by the target signal is a PDSCH.

In one embodiment, a transmission channel occupied by the target signal is a DL-SCH.

In one embodiment, a physical-layer channel occupied by the target signaling is a PSCCH.

In one embodiment, the target signaling is a piece of SCI.

In one embodiment, a physical-layer channel occupied by the target signal is a PSSCH.

In one embodiment, a transmission channel occupied by the target signal is an SL-SCH.

In one embodiment, the target signaling is used to schedule the target signal.

In one embodiment, a CRC comprised in the target-type signaling is scrambled through a C-RNTI allocated to the first node.

In one embodiment, a given control channel candidate is any of the X1 control channel candidates, for the given control channel candidates, the first node adopts a C-RNTI allocated to the first node to descramble a CRC demodulated by the given control channel candidate to judge whether the given control channel candidate carries the target signaling.

In one embodiment, the target signaling is used to indicate a first parameter out of a first parameter set, and the first parameter is used for receiving the target signal; the first parameter set is one of a first-type parameter set or a second-type parameter set; the first-type parameter set and the second-type parameter set are respectively associated with the first time-frequency-resource set and the second time-frequency-resource set; the first control channel candidate belongs to the first time-frequency-resource set, and the first parameter set is the first-type parameter set; or, the first control channel candidate belongs to the second time-frequency-resource set, and the first parameter set is the second-type parameter set.

In one subembodiment of the above embodiment, the above phrase that the first parameter is used for receiving the target signal includes: the first parameter is used to determine a Spatial Rx Parameter of the target signal.

In one subembodiment of the above embodiment, the above phrase that the first parameter is used for receiving the target signal includes: the first parameter is used to indicate a first reference signal, and a Spatial Rx Parameter of the first reference signal is used to determine a Spatial Rx Parameter of the target signal.

In one subembodiment of the above embodiment, the above phrase that the first parameter is used for receiving the target signal includes: the first parameter is used to indicate a first reference signal, and the first reference signal and the target signal are QCL.

In one subsidiary embodiment of the above two subembodiments, the first reference signal comprises a CSI-RS.

In one subsidiary embodiment of the above two subembodiments, the first reference signal comprises an SSB.

In one subsidiary embodiment of the above two subembodiments, the first reference signal is transmitted on a CSI-RS resource.

In one subsidiary embodiment of the above two subembodiments, the first reference signal is transmitted on an SSB resource.

In one subembodiment of the above embodiment, the QCL in the present disclosure is one of QCL-TypeA, QCL-TypeB, QCL-TypeC, or QCL-TypeD in TS 38.214.

In one subembodiment of the above embodiment, the first parameter set comprises Q1 parameters, the first parameter is a parameter in the first parameter set, and the Q1 is a positive integer greater than 1.

In one subsidiary embodiment of the subembodiment, any of the Q1 parameters is a TCI-State.

In one subsidiary embodiment of the subembodiment, any of the Q1 parameters corresponds to a TCI-StateID.

In one subsidiary embodiment of the subembodiment, any of the Q1 parameters corresponds to a radio signal, and the radio signal comprises a CSI-RS.

In one subsidiary embodiment of the subembodiment, any of the Q1 parameters corresponds to a radio signal, and the radio signal is transmitted in a CSI-RS resource.

In one subsidiary embodiment of the subembodiment, any of the Q1 parameters corresponds to a radio signal, and the radio signal comprises an SSB.

In one subsidiary embodiment of the subembodiment, any of the Q1 parameters corresponds to a radio signal, and the radio signal is transmitted in an SSB resource.

In one subembodiment of the above embodiment, the first time-frequency pool belongs to the first time window in time domain, and the first parameter set is the first-type parameter set.

In one subembodiment of the above embodiment, the first time-frequency pool does not belong to the first time window in time domain, and the first parameter set is the second-type parameter set.

In one subembodiment of the above embodiment, the first-type parameter set comprises Q2 first-type parameters, and the Q2 is a positive integer greater than 1.

In one subsidiary embodiment of the subembodiment, any of the Q2 first-type parameters is a TCI-State.

In one subsidiary embodiment of the subembodiment, any of the Q2 first-type parameters corresponds to a TCI-StateID.

In one subsidiary embodiment of the subembodiment, any of the Q2 first-type parameters corresponds to a radio signal, and the radio signal comprises a CSI-RS.

In one subsidiary embodiment of the subembodiment, any of the Q2 first-type parameters corresponds to a radio signal, and the radio signal is transmitted in a CSI-RS resource.

In one subsidiary embodiment of the subembodiment, any of the Q2 first-type parameters corresponds to a radio signal, and the radio signal comprises an SSB.

In one subsidiary embodiment of the subembodiment, any of the Q2 first-type parameters corresponds to a radio signal, and the radio signal is transmitted in an SSB resource.

In one subsidiary embodiment of the subembodiment, the Q2 is equal to the Q1, and the Q2 first-type parameters are respectively Q1 parameters comprised in the first parameter set.

In one subembodiment of the above embodiment, the second-type parameter set comprises Q3 second-type parameters, and the Q3 is a positive integer greater than 1.

In one subsidiary embodiment of the subembodiment, any of the Q3 second-type parameters is a TCI-State.

In one subsidiary embodiment of the subembodiment, any of the Q3 second-type parameters corresponds to a TCI-StateID.

In one subsidiary embodiment of the subembodiment, any of the Q3 second-type parameters corresponds to a radio signal, and the radio signal comprises a CSI-RS.

In one subsidiary embodiment of the subembodiment, any of the Q3 second-type parameters corresponds to a radio signal, and the radio signal is transmitted in a CSI-RS resource.

In one subsidiary embodiment of the subembodiment, any of the Q3 second-type parameters corresponds to a radio signal, and the radio signal comprises an SSB.

In one subsidiary embodiment of the subembodiment, any of the Q3 second-type parameters corresponds to a radio signal, and the radio signal is transmitted in an SSB.

In one subsidiary embodiment of the subembodiment, the Q3 is equal to the Q1, and the Q3 second-type parameters are respectively Q1 parameters comprised in the first parameter set.

In one subembodiment of the above embodiment, the target signal is a radio signal.

In one subembodiment of the above embodiment, the target signal is a baseband signal.

In one subembodiment of the above embodiment, the first-type parameter set is configured via an RRC signaling.

In one subembodiment of the above embodiment, the second-type parameter set is configured via an RRC signaling.

In one subembodiment of the above embodiment, the first-type parameter and the second-type parameter set are configured on a data channel scheduled by the first time-frequency-resource pool via an RRC signaling.

In one subembodiment of the above embodiment, the first-type parameter set and the second-type parameter set are configured through one or more fields in PDSCH-config in TS 38.331.

In one subembodiment of the above embodiment, the first-type parameter set and the second-type parameter set are configured through one or more fields in PSSCH-config in TS 38.331.

### Embodiment 7A

Embodiment 7A illustrates another flowchart of a target signal, as shown in FIG. 7A. In FIG. 7A, a first node U5A and a second node N6A are in communications via a radio link. It is particularly underlined that the order illustrated in the embodiment does not put constraints over sequences of signal transmissions and implementations. Embodiments and sub-embodiments in Embodiment 7A can be applied to Embodiment 5A if no conflict is incurred; and vice versa, embodiments and sub-embodiments in Embodiment 5A can be applied to Embodiment 7A if no conflict is incurred.

The first node U5A receives a first signaling in a first RE set in step S50A, and transmits a target signal in a target time-frequency-resource block in step S51A.

The second node N6A transmits a first signaling in a first RE set in step S60A, and receives a target signal in a target time-frequency-resource block in step S61A.

In Embodiment 7A, the first RE set is one of the K1 RE sets, and the first signaling is the first-type signaling; the first signaling is used to indicate the target time-frequency-resource block; the first signaling is used to indicate a first parameter out of a first parameter set, the first parameter is used for transmitting the target signal, and the first parameter set is one of a first-type parameter set or a second-type parameter set; whether the first time-frequency-resource pool belongs to the first time window in time domain is used to determine whether the first parameter set is the first-type parameter set or the second-type parameter set.

In one embodiment, the first signaling is an uplink grant.

In one embodiment, a transmission channel occupied by the target signal is an Uplink Shared Channel (UL-SCH).

In one embodiment, a physical-layer channel occupied by the target signal is a Physical Uplink Shared Channel (PUSCH).

In one embodiment, the first signaling is used to schedule the target signal.

In one embodiment, the above phrase that the first parameter is used for transmitting the target signal includes: the first parameter is used to determine a Spatial Tx Parameter of the target signal.

In one embodiment, the above phrase that the first parameter is used for transmitting the target signal includes: the first parameter is used to indicate a first reference signal, and a Spatial Rx Parameter of the first reference signal is used to determine a Spatial Tx Parameter of the target signal.

In one embodiment, the above phrase that the first parameter is used for transmitting the target signal includes: the first parameter is used to indicate a first reference signal, and a Spatial Tx Parameter of the first reference signal is used to determine a Spatial Tx Parameter of the target signal.

In one embodiment, the above phrase that the first parameter is used for transmitting the target signal includes: the first parameter is used to indicate a first reference signal, and the first reference signal and the target signal are QCL.

In one subembodiment of the above two embodiments, the first reference signal comprises a Sounding Reference Signal (SRS).

In one subembodiment of the above two embodiments, the first reference signal is transmitted in an SRS resource.

### Embodiment 7B

Embodiment 7B illustrates another flowchart of a target signal, as shown in FIG. 7B. In FIG. 7B, a first node U5B and a second node N6B are in communications via a radio link. It is particularly underlined that the order illustrated in the embodiment does not put constraints over sequences of signal transmissions and implementations. Embodiments and sub-embodiments in Embodiment 6B can be applied to Embodiments 5B, 6B and 8B if no conflict is incurred; and vice versa, embodiments, sub-embodiments and subsidiary embodiments in Embodiments 5B, 6B and 8B can be applied to Embodiment 7B if no conflict is incurred.

The first node U5B transmits a target signal in a target time-frequency-resource block in step S50B.

The second node N6B receives a target signal in a target time-frequency-resource block in step S60B.

In embodiment 7B, the target signaling is used to indicate the target time-frequency-resource block.

In one embodiment, the target signaling is an uplink grant.

In one embodiment, a physical-layer channel occupied by the target signal is a PUSCH.

In one embodiment, a transmission channel occupied by the target signal is a UL-SCH.

In one embodiment, the target signaling is used to indicate a first parameter out of a first parameter set, and the first parameter is used for transmitting the target signal; the first parameter set is one of a first-type parameter set or a second-type parameter set; the first-type parameter set and the second-type parameter set are respectively associated with the first time-frequency-resource set and the second time-frequency-resource set; the first control channel candidate belongs to the first time-frequency-resource set, and the first parameter set is the first-type parameter set; or, the first control channel candidate belongs to the second time-frequency-resource set, and the first parameter set is the second-type parameter set.

In one subembodiment of the above embodiment, the above phrase that the first parameter is used for transmitting the target signal includes: the first parameter is used to determine a Spatial Tx Parameter of the target signal.

In one subembodiment of the above embodiment, the above phrase that the first parameter is used for transmitting the target signal includes: the first parameter is used to indicate a first reference signal, and a Spatial Rx Parameter of the first reference signal is used to determine a Spatial Tx Parameter of the target signal.

In one subembodiment of the above embodiment, the above phrase that the first parameter is used for transmitting the target signal includes: the first parameter is used to indicate a first reference signal, and a Spatial Tx Parameter of the first reference signal is used to determine a Spatial Tx Parameter of the target signal.

In one subembodiment of the above embodiment, the above phrase that the first parameter is used for transmitting the target signal includes: the first parameter is used to indicate a first reference signal, and the first reference signal and the target signal are QCL.

In one subsidiary embodiment of the above two subembodiments, the first reference signal comprises an SRS.

In one subsidiary embodiment of the above two subembodiments, the first reference signal is transmitted in an SRS resource.

In one subembodiment of the above embodiment, the first-type parameter set and the second-type parameter set are configured through one or more fields in PUSCH-config in TS 38.331.

### Embodiment 8A

Embodiment 8A illustrates a schematic diagram of a first time-frequency-resource pool, as shown in FIG. 8A. In FIG. 8A, the first time-frequency-resource pool comprises more than 1 REs, and the first time-frequency-resource pool is associated with a first candidate parameter and a second candidate parameter; the first candidate parameter and the second candidate parameter respectively correspond to a first spatial beamforming vector and a second beamforming vector; when the first time-frequency-resource pool belongs to the first time window in the present disclosure, the first candidate parameter is used for monitoring a first-type signaling in the first time-frequency-resource pool; when the first time-frequency-resource pool does not belong to the first time window in the present disclosure, the second candidate parameter is used for monitoring a first-type signaling in the first time-frequency-resource pool.

In one embodiment, when the first time-frequency-resource pool belongs to the first time window in the present disclosure, the first node adopts the first spatial beamforming vector to monitor the first-type signaling in the first time-frequency-resource pool.

In one embodiment, when the first time-frequency-resource pool does not belong to the first time window in the present disclosure, the first node adopts the second spatial beamforming vector to monitor the first-type signaling in the first time-frequency-resource pool.

In one embodiment, the first node is configured with L1 candidate time-frequency-resource pool, the first time-frequency-resource pool is one of the L1 candidate time-frequency-resource pools, and the L1 candidate time-frequency-resource pools all belong to a second time window.

In one subembodiment of the above embodiment, when the second time window is equal to the first time window, the first node monitors the first-type signaling in the L1 candidate time-frequency-resource pools, and at least one of the L1 candidate time-frequency-resource pools and the first time-frequency-resource pool are QCL.

In one subembodiment of the above embodiment, when the second time window is not equal to the first time window, the first node monitors the first-type signaling in the L1 candidate time-frequency-resource pools, and at least one of the L1 candidate time-frequency-resource pools and the first time-frequency-resource pool are not QCL.

### Embodiment 8B

Embodiment 8B illustrates a flowchart of a first signaling and a second signaling, as shown in FIG. 8B. In FIG. 8B, a first node U7B and a second node N8B are in communications via a radio link; wherein steps in box F0B are optional. It is particularly underlined that the order illustrated in the embodiment does not put constraints over sequences of signal transmissions and implementations. Embodiments and sub-embodiments in Embodiment 8B can be applied to Embodiments 5B, 6B and 7B if no conflict is incurred; and vice versa, embodiments, sub-embodiments and subsidiary embodiments in Embodiments 5B, 6B and 7B can be applied to Embodiment 8B if no conflict is incurred.

The first node U7B receives a first signaling in step S70B, and receives a second signaling in step S71B.

The second node N8B transmits a first signaling in step S80B, and transmits a second signaling in step S81B.

In embodiment 8B, the first signaling is used to determine the first time window, and the second signaling is used to determine the second time window.

In one embodiment, the first signaling is a physical-layer signaling.

In one embodiment, the first signaling is cell-specific.

In one embodiment, the first signaling is UE-specific.

In one embodiment, the first signaling comprises a CRC, and the CRC comprised in the first signaling is scrambled by a CC-RNTI.

In one embodiment, the first signaling comprises a CRC, the CRC comprised in the first signaling is scrambled by an RNTI other than a UE-specific RNTI.

In one embodiment, the first signaling is used to indicate the first time window.

In one embodiment, the first signaling is used to indicate a third time window, and the second time window is used to determine the first time window; the third time window comprises at least one slot in time domain.

In one subembodiment of the above embodiment, the third time window comprises at least one consecutive slot in time domain.

In one subembodiment of the above embodiment, the first time window belongs to the third time window.

In one subembodiment of the above embodiment, an end time of the third time window is used to determine an end time of the first time window.

In one embodiment, the first time window comprises at least one slot in time domain.

In one embodiment, the first signaling is used to indicate a start time of the first time window in time domain.

In one embodiment, the first signaling is used to indicate a duration of the first time window in time domain.

In one embodiment, the first node U7B receives the first signaling in a first slot, and the first node U7B assumes that the first time window starts from the first slot.

In one embodiment, the first time window is a COT.

In one embodiment, the second node N8B determines a start time of the first time window through LBT.

In one embodiment, the second node N8B determines a start time of the first time window through channel sensing.

In one embodiment, a last OFDM symbol occupied by the first signaling is used to determine a start time of the first time window.

In one embodiment, the first signaling and the target time-frequency-resource pool are respectively located on different BWPs.

In one embodiment, the first signaling and the target time-frequency-resource pool are respectively located on different sub-bands.

In one embodiment, the first signaling and the target time-frequency-resource pool are respectively located on different carriers.

In one embodiment, the first signaling is located on the licensed spectrum.

In one embodiment, the second signaling is a physical-layer signaling.

In one embodiment, the second signaling is cell-specific.

In one embodiment, the second signaling is UE-specific.

In one embodiment, the second signaling comprises a CRC, and the CRC comprised in the second signaling is scrambled through a CC-RNTI.

In one embodiment, the second signaling comprises a CRC, the CRC comprised in the second signaling is scrambled by an RNTI other than a UE-specific RNTI.

In one embodiment, the second signaling is used for indicating the second time window.

In one embodiment, the second signaling is used to indicate a fourth time window, and the fourth time window is used to determine the second time window; the fourth time window comprises at least one slot in time domain.

In one subembodiment of the above embodiment, the fourth time window comprises at least one consecutive slot in time domain.

In one subembodiment of the above embodiment, the second time window belongs to the fourth time window.

In one subembodiment of the above embodiment, an end time of the fourth time window is used to determine an end time of the second time window.

In one embodiment, the second time window comprises at least one slot in time domain.

In one embodiment, the second signaling is used to indicate a start time of the second time window in time domain.

In one embodiment, the second signaling is used to indicate a duration of the second time window in time domain.

In one embodiment, the first node U7 receives the second signaling in a second slot, and the first node U7B assumes that the second time window starts from the second slot.

In one embodiment, the second time window is a COT.

In one embodiment, the second node N8B determines a start time of the second time window through LBT.

In one embodiment, the second node N8B determines a start time of the second time window through channel sensing.

In one embodiment, a last OFDM symbol occupied by the second signaling is used to determine a start time of the second time window.

In one embodiment, the second signaling and the target time-frequency-resource pool are respectively located on different BWPs.

In one embodiment, the second signaling and the target time-frequency-resource pool are respectively located on different sub-bands.

In one embodiment, the second signaling and the target time-frequency-resource pool are respectively located on different carriers.

In one embodiment, the second signaling is located on the licensed spectrum.

In one embodiment, the first time window and the second time window are orthogonal in time domain.

In one embodiment, the first time window and the second time window are overlapped in time domain.

In one embodiment, the first time window comprises the second time window.

In one embodiment, the second time window comprises the first time window.

In one embodiment, a next symbol of a last OFDM symbol occupied by the first signaling is assumed as a start time of the first time window.

In one embodiment, a next symbol of a last OFDM symbol occupied by the second signaling is assumed as a start time of the second time window.

### Embodiment 9A

Embodiment 9A illustrates a schematic diagram of first information, as shown in FIG. 9A. In FIG. 9A, the first information comprises a first field and a second field, and the first field and the second field are respectively used to indicate the first candidate parameter and the second candidate parameter; the first information also comprises a first target field and a second target field, the first target field indicates an ID adopted by the first time-frequency-resource pool, and the second target field indicates an ID of a serving cell adopting the first information.

In one embodiment, the first field occupies 7 bits.

In one embodiment, the second field occupies 7 bits.

In one embodiment, the first target field occupies 4 bits.

In one embodiment, the first target field indicates a CORESET ID.

In one embodiment, the second target field occupies 5 bits.

In one embodiment, the second target field indicates a Serving Cell ID.

In one embodiment, the first information comprises one reserved bit.

### Embodiment 9B

Embodiment 9B illustrates a schematic diagram of a first time-frequency-resource set and a second time-frequency-resource set, as shown in FIG. 9B. In FIG. 9B, the first time-frequency-resource set and the second time-frequency-resource set are overlapped in time domain, and the first time-frequency-resource set and the second time-frequency-resource set are orthogonal in frequency domain.

In one embodiment, the first time-frequency-resource set occupies more than one REs.

In one embodiment, the second time-frequency-resource set occupies more than one REs.

In one embodiment, the first time-frequency-resource set and the second time-frequency-resource set occupy a same OFDM symbol in time domain.

In one embodiment, the first node in the present disclosure respectively adopts different panels to blindly detect PDCCHs in the first time-frequency-resource set and the second time-frequency-resource set.

In one embodiment, the second node in the present disclosure respectively adopts different panels to transmit PDCCHs in the first time-frequency-resource set and the second time-frequency-resource set.

### Embodiment 10A

Embodiment 10A illustrates another schematic diagram of first information, as shown in FIG. 10A. In FIG. 10A, the first information comprises a first field, and the first field indicates the first candidate parameter; the first information also comprises a first target field and a second target field, the first target field indicates an ID adopted by the first time-frequency-resource pool, and the second target field indicates an ID of a serving cell adopting the first information; the first candidate parameter is associated with the second candidate parameter, when the first field in the first information indicates the first candidate parameter, the first candidate parameter and the second candidate parameter are used together for the first time-frequency-resource pool.

In one embodiment, the first field occupies 7 bits.

In one embodiment, the first target field occupies 4 bits.

In one embodiment, the first target field indicates a CORESET ID.

In one embodiment, the second target field occupies 5 bits.

In one embodiment, the second target field indicates a Serving Cell ID.

In one embodiment, an RRC signaling is use to indicate that the first candidate parameter is associated with the second candidate parameter.

### Embodiment 10B

Embodiment 10B illustrates a schematic diagram of a first time window and a second time window, as shown in FIG. 10B. In FIG. 10B, part of time-frequency resources comprised in the first time-frequency-resource set in the present disclosure are located in the first time window, and the second time-frequency-resource set in the present disclosure is located outside the second time window.

In one embodiment, the target time-frequency-resource pool comprises time-frequency resources located in the first time window in the first time-frequency-resource set.

In one embodiment, the target time-frequency-resource pool does not comprise time-frequency resources in the second time-frequency-resource set.

In one embodiment, the first node performs a blind detection in time-frequency resources located in the first time window in the first time-frequency-resource set.

In one embodiment, the first node does not perform a blind detection in the second time-frequency-resource set.

### Embodiment 11A

FIG. 11A illustrates a schematic diagram of a first signaling and a target signal; as shown in FIG. 11A. In FIG. 11A, a target signaling is used to indicate a first time window, and time-domain resources occupied by the first signaling and time-domain resources occupied by the target signal belong to the first time window; the first signaling is used to schedule the target signal.

In one embodiment, the target signaling and the first signaling are respectively transmitted in different frequency-band resources.

In one embodiment, the target signaling and the first signaling are transmitted in same frequency-band resources.

In one embodiment, a next symbol of a last OFDM symbol occupied by the target signaling is assumed as a start time of the first time window.

### Embodiment 11B

Embodiment 11B illustrates another schematic diagram of a first time window and a second time window, as shown in FIG. 11B. In FIG. 11B, the first time-frequency-resource set in the present disclosure is located outside the first time window, and part of time-frequency resources comprised in the second time-frequency-resource set in the present disclosure is located in the second time window.

In one embodiment, the target time-frequency-resource pool comprises time-frequency resources located in the second time window in the second time-frequency-resource set.

In one embodiment, the target time-frequency-resource pool does not comprise time-frequency resources in the first time-frequency-resource set.

In one embodiment, the first node performs a blind detection in time-frequency resources located in the second time window in the second time-frequency-resource set.

In one embodiment, the first node does not perform a blind detection in the first time-frequency-resource set.

### Embodiment 12A

Embodiment 12A illustrates a schematic diagram of a first-type parameter set and a second-type parameter set; as shown in FIG. 12A. In FIG. 12A, the first-type parameter set comprises Q2 first-type parameters, and the Q2 first-type parameters respectively correspond to Q2 first-type beamforming vectors; the second-type parameter set comprises Q3 second-type parameters, and the Q3 second-type parameters respectively correspond to Q3 second-type beamforming vectors; the first candidate parameter in the present disclosure corresponds to a first spatial beamforming vector, and the second candidate parameter in the present disclosure corresponds to a second spatial beamforming vector; the first spatial beamforming vector is associated with the Q2 first-type beamforming vectors, and the second spatial beamforming vector is associated with the Q3 second-type beamforming vectors.

In one embodiment, a space coverage of the first spatial beamforming vector comprises a space coverage corresponding to any of the Q2 first-type beamforming vectors.

In one embodiment, a space coverage of the second spatial beamforming vector comprises a space coverage corresponding to any of the Q3 second-type beamforming vectors.

### Embodiment 12B

Embodiment 12B illustrates another schematic diagram of a first time window and a second time window, as shown in FIG. 12B. In FIG. 12B, the first time-frequency-resource set in the present disclosure is located in the first time window, and the second time-frequency-resource set in the present disclosure is located in the second time window.

In one embodiment, the target time-frequency-resource pool comprises time-frequency resources located in the first time window in the first time-frequency-resource set, and the target time-frequency-resource pool comprises time-frequency resources located in the second time window in the second time-frequency-resource set.

In one embodiment, the first node performs a blind detection in both the first time-frequency-resource set and the second time-frequency-resource set.

In one embodiment, the first node respectively adopt different panels to perform blind detections in both the first time-frequency-resource set and the second time-frequency-resource set.

### Embodiment 13A

Embodiment 13A illustrates a structure block diagram in a first node, as shown in FIG. 13A. In FIG. 13A, a first node 1300A comprises a first receiver 1301A and a first transceiver 1302A.

The first receiver 1301A receives first information; and

the first transceiver 1302A monitors a first-type signaling in a first time-frequency-resource pool;

In embodiment 13A, the first information is used to determine a first candidate parameter and a second candidate parameter; a target parameter is the first candidate parameter, or a target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

In one embodiment, the first information comprises the first candidate parameter and the second candidate parameter, and the first information is used to indicate the first time-frequency-resource pool.

In one embodiment, the first information only comprises one of the first candidate parameter or the second candidate parameter, one of the first candidate parameter or the second candidate parameter that is not comprised in the first information is configured via a higher-layer signaling, and the higher-layer signaling is used to indicate that the first candidate parameter is associated with the second candidate parameter.

In one embodiment, the first transceiver 1302A receives a target signaling; and the target signaling is used to determine the first time window.

In one embodiment, the first receiver 1301A receives second information; the second information is used to indicate M1 candidate parameters, M1 being a positive integer greater than 1, and the first candidate parameter is one of the M1 candidate parameters.

In one embodiment, the first transceiver 1302A receives a first signaling in a first RE set, and the first transceiver 1302A receives a target signal in a target time-frequency-resource block; the first RE set is one of the K1 RE sets, and the first signaling is the first-type signaling; the first signaling is used to indicate the target time-frequency-resource block.

In one embodiment, the first transceiver 1302A receives a first signaling in a first RE set, and the first transceiver 1302A transmits a target signal in a target time-frequency-resource block; the first RE set is one of the K1 RE sets, and the first signaling is the first-type signaling; the first signaling is used to indicate the target time-frequency-resource block.

In one embodiment, the first signaling is used to indicate a first parameter out of a first parameter set, and the first parameter is used for receiving the target signal; the first parameter set is one of a first-type parameter set or a second-type parameter set; whether the first time-frequency-resource pool belongs to the first time window in time domain is used to determine whether the first parameter set is the first-type parameter set or the second-type parameter set.

In one embodiment, the first signaling is used to indicate a first parameter out of a first parameter set, and the first parameter is used for transmitting the target signal; the first parameter set is one of a first-type parameter set or a second-type parameter set; whether the first time-frequency-resource pool belongs to the first time window in time domain is used to determine whether the first parameter set is the first-type parameter set or the second-type parameter set.

In one embodiment, the first receiver 1301A comprises at least first four of the antenna 452, the receiver 454, the multi-antenna receiving processor 458, the receiving processor 456 and the controller/processor 459 in Embodiment 4.

In one embodiment, the first transceiver 1302A comprises at least first six of the antenna 452, the transmitter/ receiver 454, the multi-antenna transmitter 457, the transmitting processor 468, the multi-antenna receiving processor 458, the receiving processor 456 and the controller/ processor 459 in Embodiment 4.

### Embodiment 13B

Embodiment 13B illustrates a schematic diagram of a first-type parameter set and a second-type parameter set; as shown in FIG. 13B. In FIG. 13B, the first-type parameter set comprises Q2 first-type parameters, and the Q2 first-type parameters respectively correspond to Q2 first-type beamforming vectors; the second-type parameter set comprises Q3 second-type parameters, and the Q3 second-type parameters respectively correspond to Q3 second-type beamforming vectors; the first candidate parameter in the present disclosure corresponds to a first spatial beamforming vector, and the second candidate parameter in the present disclosure corresponds to a second spatial beamforming vector; the first spatial beamforming vector is associated with the Q2 first-type beamforming vectors, and the second spatial beamforming vector is associated with the Q3 second-type beamforming vectors.

In one embodiment, a space coverage of the first spatial beamforming vector comprises a space coverage corresponding to any of the Q2 first-type beamforming vectors.

In one embodiment, a space coverage of the second spatial beamforming vector comprises a space coverage corresponding to any of the Q3 second-type beamforming vectors.

### Embodiment 14A

Embodiment 14A illustrates a structure block diagram of in a second node, as shown in FIG. 14A. In FIG. 14A, a second node 1400A comprises a first transmitter 1401A and a second transceiver 1402A.

The first transmitter 1401A transmits first information; and

the second transceiver 1402A transmits a first-type signaling in a first time-frequency-resource pool;

In Embodiment 14A, the first information is used to determine a first candidate parameter and a second candidate parameter; a target parameter is the first candidate parameter, or a target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

In one embodiment, the first information comprises the first candidate parameter and the second candidate parameter, and the first information is used to indicate the first time-frequency-resource pool.

In one embodiment, the first information only comprises one of the first candidate parameter or the second candidate parameter, one of the first candidate parameter or the second candidate parameter that is not comprised in the first information is configured via a higher-layer signaling, and the higher-layer signaling is used to indicate that the first candidate parameter is associated with the second candidate parameter.

In one embodiment, the second transceiver 1402A transmits a target signaling; and the target signaling is used to determine the first time window.

In one embodiment, the first transmitter 1401A transmits second information; the second information is used to indicate M1 candidate parameters, M1 being a positive integer greater than 1, and the first candidate parameter is one of the M1 candidate parameters.

In one embodiment, the second transceiver 1402A transmits a first signaling in a first RE set; and the second transceiver 1402A transmits a target signal in a target time-frequency-resource block; the first RE set is one of the K1 RE sets, and the first signaling is the first-type signaling; the first signaling is used to indicate the target time-frequency-resource block.

In one embodiment, the second transceiver 1402A transmits a first signaling in a first RE set; and the second transceiver 1402A receives a target signal in a target time-frequency-resource block; the first RE set is one of the K1 RE sets, and the first signaling is the first-type signaling; the first signaling is used to indicate the target time-frequency-resource block.

In one embodiment, the first signaling is used to indicate a first parameter out of a first parameter set, and the first parameter is used for transmitting the target signal; the first parameter set is one of a first-type parameter set or a second-type parameter set; whether the first time-frequency-resource pool belongs to the first time window in time domain is used to determine whether the first parameter set is the first-type parameter set or the second-type parameter set.

In one embodiment, the first signaling is used to indicate a first parameter out of a first parameter set, and the first parameter is used for receiving the target signal; the first parameter set is one of a first-type parameter set or a second-type parameter set; whether the first time-frequency-resource pool belongs to the first time window in time domain is used to determine whether the first parameter set is the first-type parameter set or the second-type parameter set.

In one embodiment, the first transmitter 1401A comprises at least first four of the antenna 420, the transmitter 418, the multi-antenna transmitting processor 471, the transmitting processor 416 and the controller/processor 475 in Embodiment 4.

In one embodiment, the second transceiver 1402A comprises at least first four of the antenna 420, the transmitter /receiver 418, the multi-antenna transmitting processor 471, the transmitting processor 416, the multi-antenna receiving processor 472, the receiving processor 470, and the controller/processor 475.

### Embodiment 14B

FIG. 14B illustrates a schematic diagram of a first signaling and a target signal; as shown in FIG. 14B. In FIG. 14B, the target signaling is used to schedule the target signal.

In one embodiment, the first signaling and the target signaling are respectively transmitted in different frequency-band resources.

In one embodiment, the first signaling and the target signaling are respectively transmitted in same frequency-band resources.

In one embodiment, the second signaling and the target signaling are respectively transmitted in different frequency-band resources.

In one embodiment, the second signaling and the target signaling are respectively transmitted in same frequency-band resources.

### Embodiment 15

Embodiment 15 illustrates a structure block diagram in a first node, as shown in FIG. 15. In FIG. 15, a first node 1500 comprises a first transceiver 1501 and a second transceiver 1502.

The first transceiver 1501 receives a first information block; and

a second transceiver 1502, monitors X control channel candidates in a target time-frequency-resource pool, the X being a positive integer greater than 1;

In Embodiment 15, the first information block is used to indicate a first time-frequency-resource set and a second time-frequency-resource set; the target time-frequency-resource pool comprises time-frequency resources belonging to a first time window in time domain comprised in the first time-frequency-resource set, and the target time-frequency-resource pool comprises time-frequency resources belonging to a second time window in time domain comprised in the second time-frequency-resource set; the first time window is different from the second time window, and a relative position relation between the first time window and the second time window is used to determine time-frequency distribution of the X control channel candidates in the target time-frequency-resource pool.

In one embodiment, the first time-frequency-resource set and the second time-frequency-resource set are respectively associated with a first candidate parameter and a second candidate parameter; the first candidate parameter is used for receiving a signal in the first time-frequency-resource set, and the second candidate parameter is used for receiving a signal in the second time-frequency-resource set.

In one embodiment, the first time window and the second time window are overlapped in time domain, there at least exists one of the X control channel candidates belonging to the first time-frequency-resource set, and there at least exists another one of the X control channel candidates belonging to the second time-frequency-resource set.

In one embodiment, the first time window and the second time window are orthogonal in time domain; any of the X control channel candidates belongs to a first time-frequency resource subset, or any of the X control channel candidates belongs to a second time-frequency resource subset; the first time-frequency resource subset is time-frequency resources belonging to a first time window in time domain comprised in the first time-frequency-resource set, and the second time-frequency resource subset is time-frequency resources belonging to a second time window in time domain comprised in the second time-frequency-resource set.

In one embodiment, the first time-frequency-resource set is configured with K1 control channel candidates, the second time-frequency-resource set is configured with K2 control channel candidates, a sum of the K1 and the K2 is greater than the X, and the K1 and the K2 are positive integers greater than 1; X1 control channel candidate(s) out of the K1 control channel candidates belongs(belong) to the X control channel candidates, and X2 control channel candidate(s) out of the K2 control channel candidates belongs(belong) to the X control channel candidates; a sum of the X1 and the X2 is equal to the X; a sum of the K1 and the K2 is equal to K, and the X1 is linearly related to a ratio of the K1 to the K, and the X2 is linearly related to a ratio of the K2 to the K.

In one embodiment, the first transceiver 1501 transmits target information; the target information is used to indicate that the first node supports M1 control resource set pools, M1 being a positive integer greater than 1; the first time-frequency-resource set and the second time-frequency-resource set respectively belong to two different control resource set pools in the K1 control resource set pools.

In one embodiment, the second transceiver 1502 receives a first signaling; the first signaling is used to determine the first time window.

In one embodiment, the second transceiver 1502 receives a second signaling; and the second signaling is used to determine the second time window.

In one embodiment, the second transceiver 1502 receives a target signaling in a first control channel candidate, and the second transceiver 1502 receives a target signal in a target time-frequency-resource block; the first control channel candidate is one of the X control channel candidates; and the target signaling is used to indicate the target time-frequency-resource block.

In one embodiment, the second transceiver 1502 receives a target signaling in a first control channel candidate, and the second transceiver 1502 transmits a target signal in a target time-frequency-resource block; the first control channel candidate is one of the X control channel candidates; and the target signaling is used to indicate the target time-frequency-resource block.

In one embodiment, the target signaling is used to indicate a first parameter out of a first parameter set, and the first parameter is used for receiving the target signal, or the first parameter is used for transmitting the target signal; the first parameter set is one of a first-type parameter set or a second-type parameter set; the first-type parameter set and the second-type parameter set are respectively associated with the first time-frequency-resource set and the second time-frequency-resource set; the first control channel candidate belongs to the first time-frequency-resource set, and the first parameter set is the first-type parameter set; or, the first control channel candidate belongs to the second time-frequency-resource set, and the first parameter set is the second-type parameter set.

In one embodiment, the first transceiver 1501 comprises at least first six of the antenna 452, the transmitter/ receiver 454, the multi-antenna transmitter 457, the transmitting processor 468, the multi-antenna receiving processor 458, the receiving processor 456 and the controller/ processor 459 in Embodiment 4.

In one embodiment, the second transceiver 1502 comprises at least first six of the antenna 452, the transmitter/ receiver 454, the multi-antenna transmitter 457, the transmitting processor 468, the multi-antenna receiving processor 458, the receiving processor 456 and the controller/ processor 459 in Embodiment 4.

### Embodiment 16

Embodiment 16 illustrates a structure block diagram of in a second node, as shown in FIG. 16. In FIG. 16, a second node 1600 comprises a third transceiver 1601 and a fourth transceiver 1602.

The third transceiver 1601 transmits a first information block; and
the fourth transceiver 1602 transmits a target signaling in a target time-frequency-resource pool;
in Embodiment 16, the target time-frequency-resource pool comprises X control channel candidates, the X being a positive integer greater than 1; the target signaling occupies one of the X control channel candidates; the first information block is used to indicate a first time-frequency-resource set and a second time-frequency-resource set; the target time-frequency-resource pool comprises time-frequency resources belonging to a first time window in time domain comprised in the first time-frequency-resource set, and the target time-frequency-resource pool comprises time-frequency resources belonging to a second time window in time domain comprised in the second time-frequency-resource set; the first time window is different from the second time window, and a relative position relation between the first time window and the second time window is used to determine time-frequency distribution of the X control channel candidates in the target time-frequency-resource pool.

In one embodiment, the first time-frequency-resource set and the second time-frequency-resource set are respectively associated with a first candidate parameter and a second candidate parameter; the first candidate parameter is used for receiving a signal in the first time-frequency-resource set, and the second candidate parameter is used for receiving a signal in the second time-frequency-resource set.

In one embodiment, the first time window and the second time window are overlapped in time domain, there at least exists one of the X control channel candidates belonging to the first time-frequency-resource set, and there at least exists another one of the X control channel candidates belonging to the second time-frequency-resource set.

In one embodiment, the first time window and the second time window are orthogonal in time domain; any of the X control channel candidates belongs to a first time-frequency resource subset, or any of the X control channel candidates belongs to a second time-frequency resource subset; the first time-frequency resource subset is time-frequency resources belonging to a first time window in time domain comprised in the first time-frequency-resource set, and the second time-frequency resource subset is time-frequency resources belonging to a second time window in time domain comprised in the second time-frequency-resource set.

In one embodiment, the first time-frequency-resource set is configured with K1 control channel candidates, the second time-frequency-resource set is configured with K2 control channel candidates, a sum of the K1 and the K2 is greater than the X, and the K1 and the K2 are positive integers greater than 1; X1 control channel candidate(s) out of the K1 control channel candidates belongs(belong) to the X control channel candidates, and X2 control channel candidate(s) out of the K2 control channel candidates belongs(belong) to the X control channel candidates; a sum of the X1 and the X2 is equal to the X; a sum of the K1 and the K2 is equal to K, and the X1 is linearly related to a ratio of the K1 to the K, and the X2 is linearly related to a ratio of the K2 to the K.

In one embodiment, the third transceiver 1601 receives target information; the target information is used to indicate that a transmitter of the target information supports M1 control resource set pools, M1 being a positive integer greater than 1; the first time-frequency-resource set and the second time-frequency-resource set respectively belong to two different control resource set pools in the K1 control resource set pools.

In one embodiment, the fourth transceiver 1602 transmits a first signaling; and the first signaling is used to determine the first time window.

In one embodiment, the fourth transceiver 1602 transmits a second signaling; and the second signaling is used to determine the second time window.

In one embodiment, the fourth transceiver 1602 determines a first control channel candidate; and the fourth transceiver 1602 transmits a target signal; the first control channel candidate is one of the X control channel candidates; the target signaling occupies the first control channel candidate; and the target signaling is used to indicate the target time-frequency-resource block.

In one embodiment, the fourth transceiver 1602 determines a first control channel candidate; and the fourth transceiver 1602 receives a target signal; the first control channel candidate is one of the X control channel candidates; the target signaling occupies the first control channel candidate; and the target signaling is used to indicate the target time-frequency-resource block.

In one embodiment, the target signaling is used to indicate a first parameter out of a first parameter set, and the first parameter is used for receiving the target signal, or the first parameter is used for transmitting the target signal; the first parameter set is one of a first-type parameter set or a second-type parameter set; the first-type parameter set and the second-type parameter set are respectively associated with the first time-frequency-resource set and the second time-frequency-resource set; the first control channel candidate belongs to the first time-frequency-resource set, and the first parameter set is the first-type parameter set; or, the first control channel candidate belongs to the second time-frequency-resource set, and the first parameter set is the second-type parameter set.

In one embodiment, the third transceiver 1601 comprises at least first six of the antenna 420, the transmitter /receiver 418, the multi-antenna transmitting processor 471, the transmitting processor 416, the multi-antenna receiving processor 472, the receiving processor 470, and the controller/processor 475.

In one embodiment, the fourth transceiver 1602 comprises at least first six of the antenna 420, the transmitter /receiver 418, the multi-antenna transmitting processor 471, the transmitting processor 416, the multi-antenna receiving processor 472, the receiving processor 470, and the controller/processor 475.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node and the second node in the present disclosure includes but is not limited to mobile phones, tablet computers, notebooks, network cards, low-consumption equipment, enhanced MTC (eMTC) terminals, NB-IOT terminals, vehicle-mounted communication equipment, vehicles, cars, RSUs, aircrafts, diminutive airplanes, unmanned aerial vehicles, telecontrolled aircrafts and other wireless communication devices. The base station in the present disclosure includes but is not limited to macro-cellular base stations, micro-cellular base stations, home base stations, relay base station, eNB, gNB, Transmitter Receiver Point (TRP), GNSS, relay satellites, satellite base stations, space base stations, RSUs and other radio communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A first node for wireless communications, comprising:
a first receiver, which receives first information; and
a first transceiver, which monitors a first-type signaling in a first time-frequency-resource pool;
wherein the first information is used to determine a first candidate parameter and a second candidate parameter; a target parameter is the first candidate parameter, or a target parameter is the second candidate parameter; the first time-frequency-resource pool comprises K1 Resource Element (RE) sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the Kl is a positive integer greater than 1.

2. The first node according to claim 1, wherein the first information comprises the first candidate parameter and the second candidate parameter, and the first information is used to indicate the first time-frequency-resource pool.

3. The first node according to claim 1, wherein the first information only comprises one of the first candidate parameter or the second candidate parameter, one of the first candidate parameter or the second candidate parameter that is not comprised in the first information is configured via a higher-layer signaling, and the higher-layer signaling is used to indicate that the first candidate parameter is associated with the second candidate parameter.

4. The first node according to any of claims 1, wherein the first transceiver receives a target signaling, and the target signaling is used to determine the first time window.

5. The first node according to any of claims 1, wherein the first receiver receives second information, the second information is used to indicate M1 candidate parameters, M1 being a positive integer greater than 1, and the first candidate parameter is one of the M1 candidate parameters.

6. The first node according to any of claims 1, wherein the first transceiver receives a first signaling in a first RE set, and the first transceiver operates a target signal in a target time-frequency-resource block; the first RE set is one of the K1 RE sets, and the first signaling is the first-type signaling; the first signaling is used to indicate the target time-frequency-resource block; the operating action is transmitting, or the operating action is receiving.

7. The first node according to claim 6, wherein the first signaling is used to indicate a first parameter out of a first parameter set, and the first parameter is used for receiving the target signal, or the first parameter is used for transmitting the target signal; the first parameter set is one of a first-type parameter set or a second-type parameter set; whether the first time-frequency-resource pool belongs to the first time window in time domain is used to determine whether the first parameter set is the first-type parameter set or the second-type parameter set.

8. The first node according to any of claims 1, wherein a start time of the first time window in time domain is indicated via a physical-layer dynamic signaling transmitted by a transmitter of the first information.

9. The first node according to any of claims 1, wherein the above phrase that the target parameter is used for receiving the first-type signaling includes: the target parameter is used to indicate a target reference signal, and the target reference signal is Quasi Co-located (QCL) with the first-type signaling.

10. A second node for wireless communications, comprising:
a first transmitter, which transmits first information; and
a second transceiver, which transmits a first-type signaling in a first time-frequency-resource pool;
wherein the first information is used to determine a first candidate parameter and a second candidate parameter; a target parameter is the first candidate parameter, or a target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

11. The second node according to claim 10, wherein the first information comprises the first candidate parameter and the second candidate parameter, and the first information is used to indicate the first time-frequency-resource pool.

12. The second node according to claim 10, wherein the first information only comprises one of the first candidate parameter or the second candidate parameter, one of the first candidate parameter or the second candidate parameter that is not comprised in the first information is configured via a higher-layer signaling, and the higher-layer signaling is used to indicate that the first candidate parameter is associated with the second candidate parameter.

13. The second node according to any of claims 10, wherein the second transceiver transmits a target signaling, and the target signaling is used to determine the first time window.

14. The second node according to any of claims 10, wherein the first transmitter transmits second information, the second information is used to indicate M1 candidate parameters, M1 being a positive integer greater than 1, and the first candidate parameter is one of the M1 candidate parameters.

15. The second node according to any of claims 10, wherein the second transceiver transmits a first signaling in a first RE set, and the second transceiver transmits a target signal in a target time-frequency-resource block, or the second transceiver receives a target signal in a target time-frequency-resource block; the first RE set is one of the K1 RE sets, and the first signaling is the first-type signaling; the first signaling is used to indicate the target time-frequency-resource block.

16. The second node according to claim 15, wherein the first signaling is used to indicate a first parameter out of a first parameter set, the first parameter is used for transmitting the target signal, or the first parameter is used for receiving the target signal; the first parameter set is one of a first-type parameter set or a second-type parameter set; whether the first time-frequency-resource pool belongs to the first time window in time domain is used to determine whether the first parameter set is the first-type parameter set or the second-type parameter set.

17. The second node according to any of claims 10, wherein a start time of the first time window in time domain is indicated via a physical-layer dynamic signaling transmitted by the second node.

18. The second node according to any of claims 10, wherein the above phrase that the target parameter is used for receiving the first-type signaling includes: the target parameter is used to indicate a target reference signal, and the target reference signal is QCL with the first-type signaling.

19. A method in a first node for wireless communications, comprising:
receiving first information; and
monitoring a first-type signaling in a first time-frequency-resource pool;
wherein the first information is used to determine a first candidate parameter and a second candidate parameter; a target parameter is the first candidate parameter, or a target parameter is the second candidate parameter; the first time-frequency-resource pool comprises K1 RE sets, the first-type signaling occupies one of the K1 RE sets; the target parameter is used for receiving the first-type signaling; whether the first time-frequency-resource pool belongs to a first time window in time domain is used to determine whether the target parameter is the first candidate parameter or the second candidate parameter; the K1 is a positive integer greater than 1.

20. The method in a first node according to claim 19, wherein the first information comprises the first candidate parameter and the second candidate parameter, and the first information is used to indicate the first time-frequency-resource pool.
